(19) United States
(12) Patent Application Publication
(10) Pub. No.: US 2018/0244846 A1
(43) Pub. Date: Aug. 30, 2018

(54) POLY(ARYL ETHER) ADHESIVE COMPOSITIONS, POLYMER-METAL JUNCTIONS INCORPORATING POLY(ARYL ETHER) ADHESIVE COMPOSITIONS, AND CORRESPONDING FORMATION METHODS

(71) Applicant: SOLVAY SPECIALTY POLYMERS USA, LLC, Alpharetta, GA (US)

(72) Inventors: John Scott FLANAGAN, Chamblee, GA (US); Chuck HOPIN, Johns Creek, GA (US); Robert CRISLER, Flowery Branch, GA (US); Eugenia NARH, Arlington, TX (US); William W. Walter LOONEY, Sugar Hill, GA (US); Keshav S. GAUTAM, Duluth, GA (US); Mohammad Jamal EL-HIBRI, Atlanta, GA (US)

(21) Appl. No.: 15/757,953

(22) PCT Filed: Sep. 6, 2016
(86) PCT No.: PCT/EP2016/070969

§ 371 Date: Mar. 6, 2018

Related U.S. Application Data
(60) Provisional application No. 62/216,143, filed on Sep. 9, 2015.

(30) Foreign Application Priority Data
Nov. 23, 2015 (EP) 15195874.1

(51) Int. Cl. C08G 65/40; C08G 65/48; C09J 171/08; B29C 70/74; H01B 3/42

(52) U.S. Cl. CPC C08G 65/4056; C08G 65/48; C08G 65/4006; C09J 171/08; B29K 2071/00; H01B 3/427; C08G 2650/40; C08G 2650/50; C08G 2650/64; B29C 70/74

(57) ABSTRACT

Described herein are poly(aryl ether) (“PAE”) adhesive compositions including at least one PAE chelating agent. The PAE chelating agent is a PAE polymer. In some embodiments, the PAE adhesive composition can optionally include one or more poly(aryl ether ketone) polymers distinct from the PAE chelating agent. The PAE adhesive composition can be incorporated into polymer-metal junctions to improve the strength thereof. In some such embodiments, the adhesive composition can be disposed between a portion of the plastic component and a portion of the metal component of the polymer-metal junction. In some embodiments, the PAE adhesive compositions can be used in conjunction with one or more adhesion promoters distinct from the PAE adhesive composition. In some embodiments, polymer-metal junctions including the PAE chelating agent can be desirably incorporated in mobile electronic device components.

### CROSS REFERENCE TO RELATED APPLICATIONS

This application claims priority to U.S. provisional patent application No. 62/216,143, filed Sep. 9, 2015 and to European application No. 15195874.1 filed on Nov. 23, 2015, the whole content of each of these applications being incorporated herein by reference for all purposes.

### FIELD OF THE INVENTION

The invention relates to poly(aryl ether) adhesive compositions including at least one poly(aryl ether) chelating agent. The invention also relates to polymer-metal junctions incorporating the poly(aryl ether) adhesive compositions and corresponding fabrication methods. Additionally, the invention relates to mobile electronic device components and mobile electronic devices incorporating the polymer-metal junctions.

### BACKGROUND OF THE INVENTION

The polymer-metal junction is ubiquitous interface in a wide variety of application settings. For example, in plumbing, overmolded inserts can provide for connections and fluid flow passageways between different plumbing fixtures (e.g., pipes). As another example, in electrical wiring applications, polymeric sheaths are formed around the electrically conductive metal core to provide abrasion protection, corrosion protection, and dielectric insulation to the underlying conductive core. As a further example, in mobile electronic devices (e.g. mobile phones and tablets), polymer materials are highly desirable due to their light weight and strength, relative to metal compositions. Correspondingly, many mobile electronic devices incorporate polymer housings (e.g., cases) or polymer supports for internal electronic components into their designs, to reduce weight while providing desirable levels of strength and flexibility. Accordingly, application settings involving polymer-metal junction designs rely heavily on the strength of the metal-polymer junction.

Nowadays, mobile electronic devices such as mobile phones, personal digital assistants (PDAs), laptop computers, tablet computers, smart watches, portable audio players, and so on, are in widespread use around the world. Mobile electronic devices are getting smaller and lighter for even more portability and convenience, while at the same time becoming increasingly capable of performing more advanced functions and services, both due to the development of the devices and network systems.

While in the past, low density metals such as magnesium or aluminum, were the materials of choice for mobile electronic parts, synthetic resins have progressively come as at least partial replacement, for costs reasons (some of these less dense metals such as magnesium are somewhat expensive, and manufacturing the often small and/or intricate parts needed is expensive), for overriding design flexibility limitations, for further weight reduction, and for providing un-restricted aesthetic possibilities, thanks to the colorability of the same. It is therefore desirable that plastic mobile electronic parts are made from materials that are easy to process into various and complex shapes, are able to withstand the rigors of frequent use, including outstanding impact resistance, generally possess electrical insulating capabilities, and which meet challenging aesthetic demands while not interfering with their intended operability. Nevertheless, in certain cases, plastics may not have the strength and/or stiffness to provide for all-plastic structural parts in mobile electronic devices, and metal/synthetic resins assemblies are often encountered.

Providing polymeric compositions having desirable mechanical performance for ensuring structural support (tensile strength) and yet desirable flexibility for enabling mounting/assembling (e.g., elongation at break), able to withstand impact and aggressive chemicals (e.g., impact and chemical resistance, respectively), having good colorability, and which can be easily processed is a continuous challenge in this field, and while solutions based on a variety of plastics have already been attempted, still continuous improvements to reach unmet challenges are required.

### BRIEF DESCRIPTION OF THE DRAWINGS

FIG. 1 is a schematic representation of a polymer-metal junction prior to thermal treatment (bottom panel), after thermal treatment for time tᵢ (middle panel) and after thermal treatment at time t₂>t₁ (top panel).

FIG. 2 is a structural representation of DFBCH with atom numbering.

FIG. 3 is a ¹HNMR spectrum of DFBCH.

FIG. 4 is a ¹³CNMR spectrum of DFBCH.

FIG. 5 is a structural representation of HQCH with atom numbering.

FIG. 6 is a ¹FINMR spectrum of HQCH.

FIG. 7 is a ¹³CNMR spectrum of HQCH.

FIG. 8 is a structural representation of poly(thiomethylimine hydroquinone) with atom numbering.

FIG. 9 is a ¹HNMR spectrum of poly(thiomethylimine hydroquinone).

FIG. 10 is a ¹³CNMR spectrum of poly(thiomethylimine hydroquinone).

FIG. 11 is a structural representation of poly(thiomethylimine biphenol) with atom numbering.

FIG. 12 is a representative ¹HNMR of poly(thiomethylimine biphenol).

FIG. 13 is a representative ¹³CNMR spectrum of poly(thiomethylimine biphenol).

FIG. 14 is a structural representation of a poly(thiomethylimine hydroquinone)-poly(thiomethylimine biphenol) copolymer with atom numbering.

FIG. 15 a ¹HNMR of a poly(thiomethylimine hydroquinone)-poly(thiomethylimine biphenol) copolymer.

FIG. 16 a ¹³CNMR spectrum of a poly(thiomethylimine hydroquinone)-poly(thiomethylimine biphenol) copolymer.

FIG. 17 is a structural representation of a poly(thiomethylimine hydroquinone)-PEEK copolymer with atom numbering.

FIG. 18 a ¹HNMR of a poly(thiomethylimine hydroquinone)-PEEK copolymer.

FIG. 19 a ¹³CNMR spectrum of a poly(thiomethylimine hydroquinone)-PEEK copolymer.

FIG. 20 is a graph showing FTIR spectra of a film taken before autoclaving and after the 1^{st}, 5^{th} and 20^{th} autoclave cycles.

### DETAILED DESCRIPTION OF THE INVENTION

Described herein are poly (aryl ether) (“PAE”) adhesive compositions including at least one PAE chelating agent. The PAE chelating agent is a PAE polymer. In some embodiments, the PAE adhesive composition can optionally include one or more poly(aryl ether ketone) (“PAEK”) polymers distinct from the PAE chelating agent. The adhesive composition can be incorporated into polymer-metal junctions to improve the strength thereof. In some such embodiments, the adhesive composition can be disposed between a portion of the plastic component and a portion of the metal component of the polymer-metal junction. In some embodiments, the PAE adhesive compositions can be used in conjunction with one or more adhesion promoters distinct from the PAE adhesive composition. For clarity, because the PAE adhesive compositions can be considered adhesion promoters, as used herein, “adhesion promoters” refers to adhesion promoters distinct from the PAE adhesive composition. In some embodiments, polymer-metal junctions including the PAE chelating agent can be desirably incorporated in mobile electronic device components.

For the sake of clarity, throughout the present application:
the term “halogen” includes fluorine, chlorine, bromine and iodine, unless indicated otherwise;
the adjective “aromatic” denotes any mono- or polynuclear cyclic group (or moiety) having a number of π electrons equal to 4n+2, wherein n is 0 or any positive integer; an aromatic group (or moiety) can be an aryl and arylene groups (or moiety) moieties.
an “aryl group” or “aryl” is a hydrocarbon monovalent group consisting of one core composed of one benzenic ring or of a plurality of benzenic rings fused together by sharing two or more neighboring ring carbon atoms, and of one end. Non limitative examples of aryl groups are phenyl, naphthyl, anthryl, phenanthryl, tetracenyl, triphenylyl, pyrenyl, and perylenyl groups. The end of an aryl group is a free electron of a carbon atom contained in a (or the) benzenic ring of the aryl group, wherein an hydrogen atom linked to said carbon atom has been removed. The end of an aryl group is capable of forming a linkage with another chemical group.
an “arylene group” or “arylene” is a hydrocarbon divalent group consisting of one core composed of one benzenic ring or of a plurality of benzenic rings fused together by sharing two or more neighboring ring carbon atoms, and of two ends. Non limitative examples of arylene groups are phenylenes, naphthylenes, anthrylenes, phenanthrylenes, tetracenylenes, triphenylylenes, pyrenylenes, and perylenylenes. An end of an arylene group is a free electron of a carbon atom contained in a (or the) benzenic ring of the arylene group, wherein an hydrogen atom linked to said carbon atom has been removed.

Each end of an arylene group is capable of forming a linkage with another chemical group.
the term “hydrocarbyl” as used herein means the monovalent moiety obtained upon removal of a hydrogen atom from a parent hydrocarbon. Representative of hydrocarbyl are alkyls of 1 to 25 carbon atoms, inclusive such as methyl, ethyl, propyl, butyl, pentyl, hexyl, heptyl, octyl, nonyl, undecyl, decyl, dodecyl, octadecyl, nonodecyl eicosyl, heneicosyl, docosyl, tricosyl, tetracosyl, pentacosyl and the isomeric forms thereof; aryls of 6 to 25 carbon atoms, inclusive, such as phenyl, tolyl, xylyl, napthyl, biphenyl, tetraphenyl and the like; aralkyls of 7 to 25 carbon atoms, inclusive, such as benzyl, phenethyl, phenpropyl, phenbutyl, phenhexyl, napthoctyl and the like; and cycloalkyls of 3 to 8 carbon atoms, inclusive, such as cyclopropyl, cyclobutyl, cyclopentyl, cyclohexyl, cycloheptyl, cyclooctyl and the like.
the term “halogen-substituted hydrocarbyl” as used herein means the hydrocarbyl moiety as previously defined wherein one or more hydrogen atoms have been replaced with halogen (chlorine, bromine, iodine, fluorine).

The PAE adhesive compositions can significantly improve the strength of polymer-metal junctions. In general, the PAE adhesive compositions improve the strength of a junction having a metal substrate and an overmolded polymer composition. The PAE adhesive compositions can be disposed between the overmolded polymer and the substrate to improve the adhesion between the substrate and the overmolded polymer. For example, it has been observed that poly(ether ether ketone) (“PEEK”) polymers injection molded onto a flat metal substrate (e.g., aluminum, stainless steel, copper, nickel or titanium) results in temporary adhesion between the PEEK and the metal substrate. After the overmolded substrate cools, however, the PEEK layer will spontaneously delaminate. It has been found that the PAE adhesive compositions described herein can significantly improve the peel strength of PAEK polymers molded over metal substrates. In some embodiments in which a PAE adhesive composition provides an adhesive between a PAEK polymer and a metal substrate, the PAEK polymer can have a peel strength of between about 1 pound force per inch (“lbf”) to about 60 lbf, to about 50 lbf, to about 40 lbf, or to about 30 lbf. In some such embodiments, the PAEK polymer can have a peel strength of at least about 5 lbf or at least about 10 lbf. A person of ordinary skill in the art will recognize additional ranges of peel strength within the explicitly disclosed ranges are contemplated and within the scope of the present disclosure. Peel strength can be measured according to the ASTM D3330 standard, as described in the Examples.

Additionally, the PAE adhesive compositions can significantly improve the lap shear strength of polymer-metal junctions. In some embodiments in which a PAE adhesive composition provides adhesion between a PAEK polymer and metal substrate, the PAEK polymer can have a lap shear strength of at least about 1 mega Pascal (“MPa”), at least about 6 MPa, at least about 8MPa, at least about 9 MPa or at least about 10 MPa. In some such embodiments, the PAEK polymer can have a lap shear strength of no more than about 60 MPa, no more than about 50 MPa or no more than about 80 MPa. A person of ordinary skill in the art will recognize additional lap shear strength ranges between the explicitly disclosed ranges are contemplated and within the scope of the present disclosure. Lap shear strength can be measured according to the ASTM D1002 standard, as further described below in the Examples.

### The Poly(Aryl Ether) Adhesive Composition: Structure and Properties

The PAE adhesive composition includes at least one PAE chelating agent and can optionally include one or more PAEK polymers. The PAE chelating agent is a PAE polymer containing a recurring unit having a chelating group. The PAE polymers of interest herein are any polymers containing at least 1 mole percent (“mol %”) of recurring unit (Rₚₐₑ) having a Ar—C(=M)-Ar′ group, where Ar and Ar′, the same or different, are aromatic groups and M is a chelating group represented by the following formula:

═N—R₃ [symbol] =ER₁R₂ (I),

where R₁ and R₂ are each an optional group when, if present, are independently selected from the group consisting of a hydrogen, a halogen, an alkyl, an alkenyl, an alkynyl, an aryl, an ether, a thioether, a carboxylic acid, an ester, an amide, an imide, an alkali or alkaline earth metal sulfonate, an alkyl sulfonate, an alkali or alkaline earth metal phosphonate, an alkyl phosphonate, an amine and a quaternary ammonium; where R₃ is C₂ to C₅₀ linear, branched or cyclic hydrocarbon; where N and E and separated by at least 2 carbon atoms and where E has at least one lone pair of electrons and is selected from group VA and VIA elements. As used herein, a lone pair of electrons refers to a pair of valence electrons that are not included in a covalent bond. In Formula (I), [symbol] indicates that the bond can be a single bond or a double bond. In some embodiments, the PAE polymer can contain at least about 5 mol %, at least about 10 mol %, at least about 20 mol %, at least about 30 mol %, at least about 40 mol %, at least about 50 mol %, at least about 60 mole percent (“mol %”), at least about 70 mol %, at least about 80 mol %, at least about 90 mol %, at least about 95 mol % or at least about 99 mol % recurring unit (Rₚₐₑ). In some embodiments, the PAE polymer can consist essentially of recurring unit (Rₚₐₑ).

In some embodiments, recurring units (Rₚₐₑ) can be represented by a formula selected from the group consisting of formulae (J-A) to (J-P), herein below:

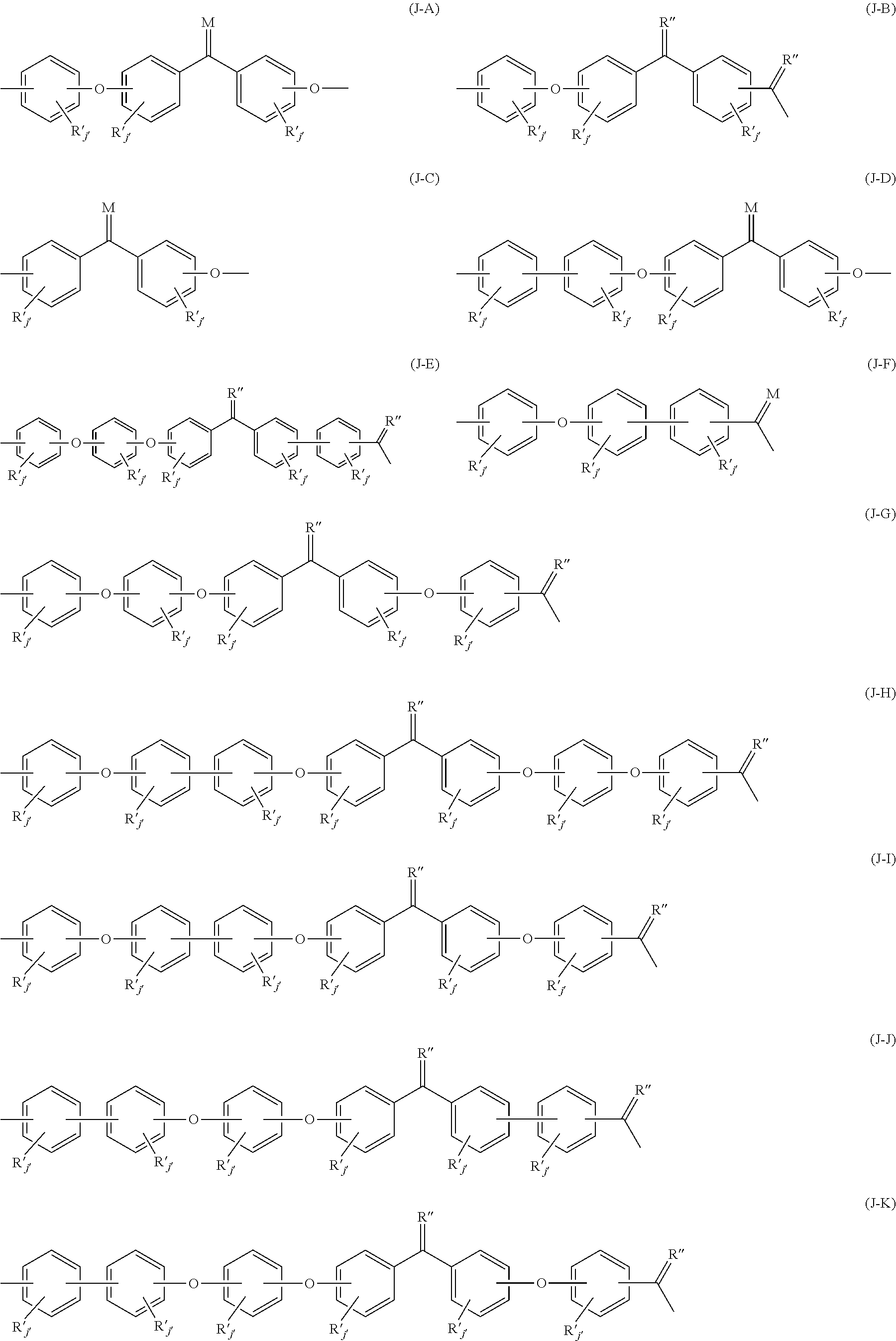

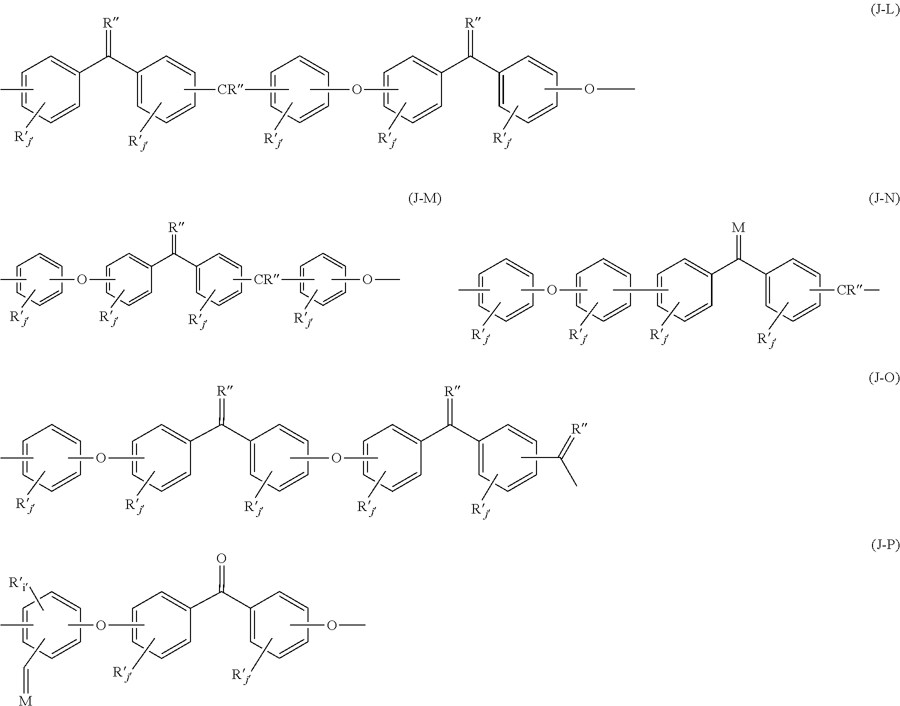

where (i) each R′ᵢ, and R′ⱼ′ is independently selected from the group consisting of a halogen, an alkyl, an alkenyl, an alkynyl, an aryl, an ether, a thioether, a carboxylic acid, an ester, an amide, an imide, an alkali or alkaline earth metal sulfonate, an alkyl sulfonate, an alkali or alkaline earth metal phosphonate, an alkyl phosphonate, an amine and a quaternary ammonium; (ii) each R″ is independently selected from an O atom and M group, such that at least one R″ is an M; (iii) each j′ is an independently selected integer from 0 to 4 and (iv) i′ is an integer from 0 to 3. As used herein, “independently selected” means that the corresponding units can be the same or different and the selection of each unit can be made independently from the selection of any other unit. For example, where Rⱼ is independently selected from a halogen or an alkyl, and where j=2, R₁ can be a halogen or an alkyl, R₂ can be a halogen or an alkyl, and R₁ can be the same or different than R₂. Also, as used herein, when the subscript of R equals zero, the corresponding moiety is unsubstituted by an R group (equivalently, each R═H and the subscript has its maximum indicated value). In some embodiments, recurring unit (Rₚₐₑ) is represented by the formula (J-A) or (J-D).

In some embodiments, the respective phenylene moieties of recurring unit (Rₚₐₑ) can independently have 1,2-, 1,4- or 1,3-linkages to the other moieties different from R′ in the recurring unit. In some embodiments, the phenylene moieties have 1,3- or 1,4-linkages. In further embodiments, the phenyl moieties have 1,4-linkages.

Furthermore, in some embodiments, j′ in recurring unit (Rₚₐₑ) can be at each occurrence zero; that is to say that the phenylene moieties have no other substituents than those enabling linkage in the main chain of the polymer. In some such embodiments, recurring unit (Rₚₐₑ) can be represented by a formula selected from the group of formulae (J′-A) to (J′-P) below:

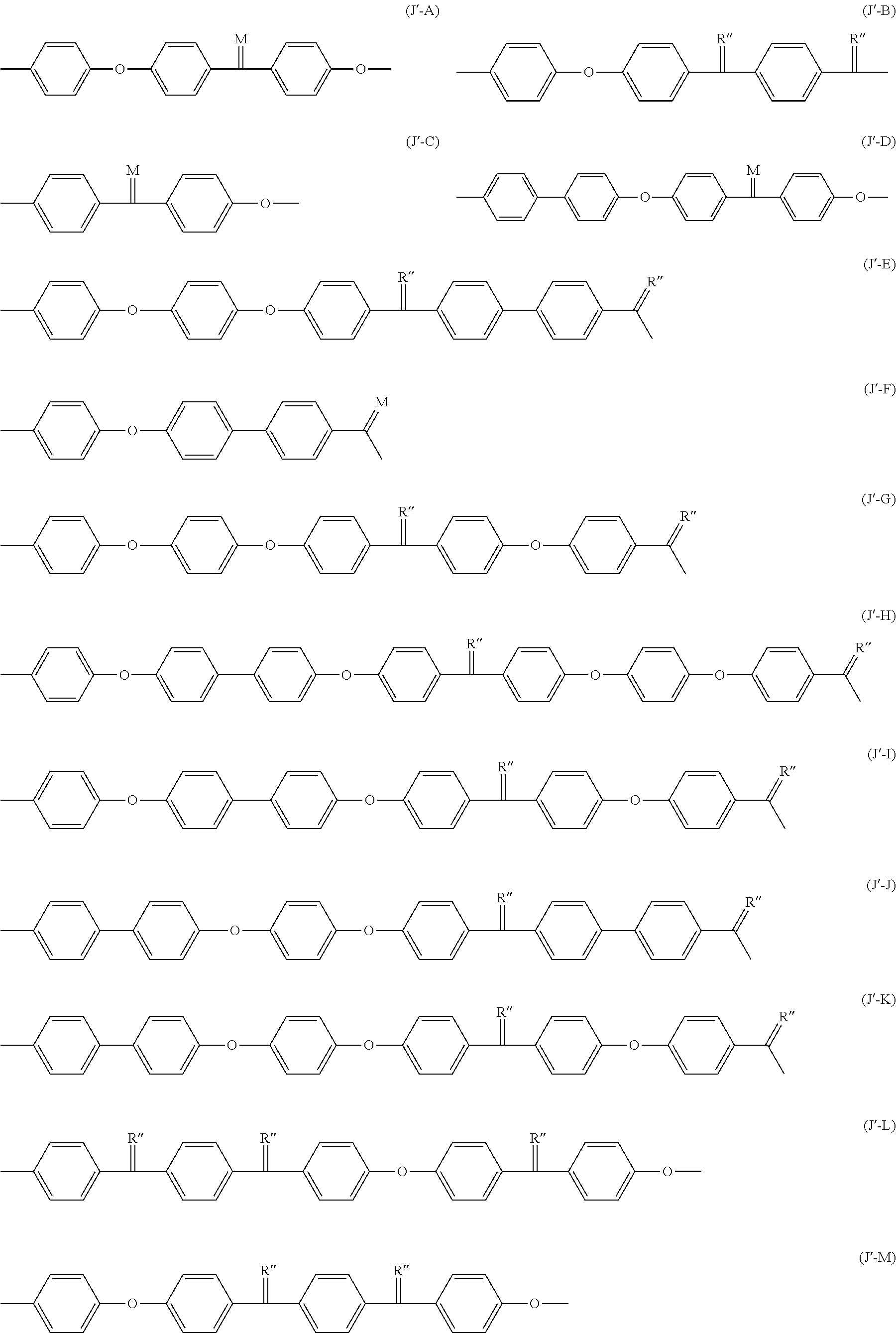

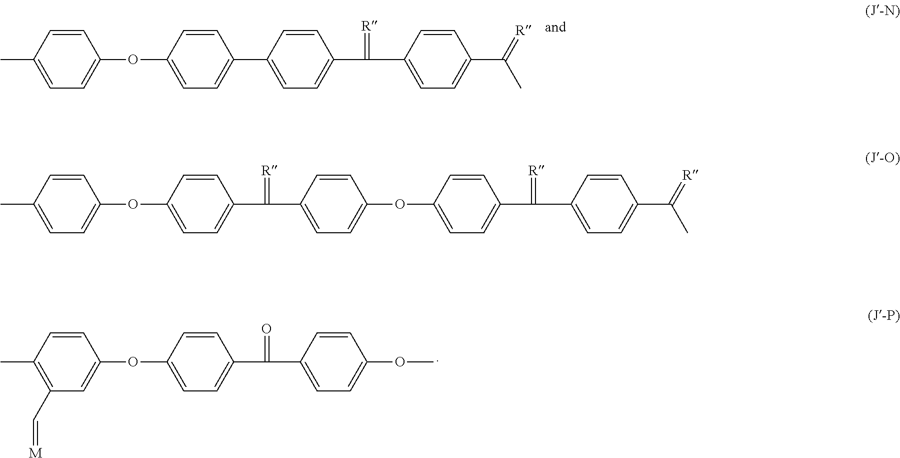

In some embodiments, recurring unit (Rₚₐₑ) is represented by the formula (J′-A) or (J′-D).

The PAE polymer can be a homopolymer or copolymer (random, alternate or block). In some embodiments in which the PAE polymer is a copolymer, it can contain recurring unit (Rₚₐₑ*), distinct from (Rₚₐₑ), where recurring unit (Rₚₐₑ*) includes a chelating group as described above with respect to recurring unit (Rₚₐₑ). In such embodiments, the chelating group in recurring unit (Rₚₐₑ*) can be the same or different as that in recurring unit (Rₚₐₑ). In some embodiments recurring unit (Rₚₐₑ*) and recurring unit (Rₚₐₑ) are independently selected from the group of formula consisting of formulae (J-A)−(J-O) and (J′-A)−(J′-O).

In some embodiments in which the PAE polymer is a copolymer, recurring unit (Rₚₐₑ**) can be free of a chelating group. In some such embodiments, recurring unit (Rₚₐₑ**) can be represented by a formula selected from the group of formulae below:

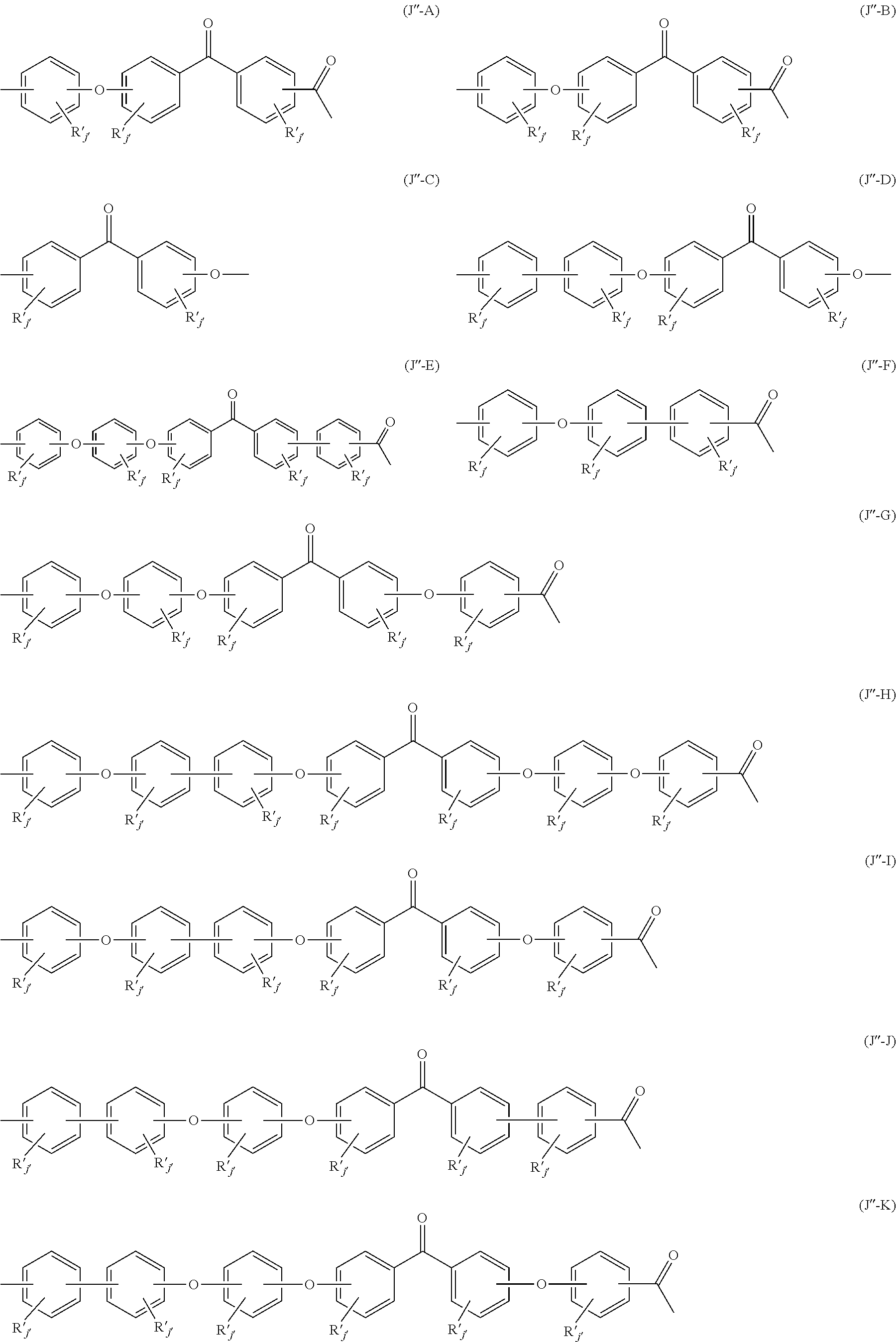

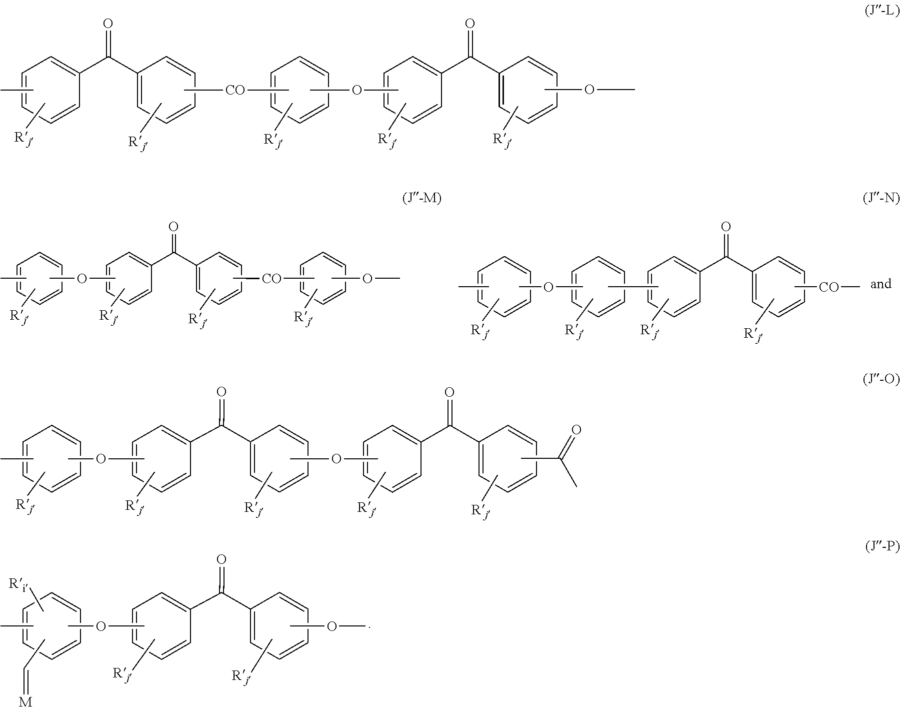

In some embodiments, recurring unit (Rₚₐₑ**) can be represented by Formula (J″-A) or (J″-D).

In some embodiments, recurring unit (Rₚₐₑ**) can be represented by a formula selected from the group of formulae below:

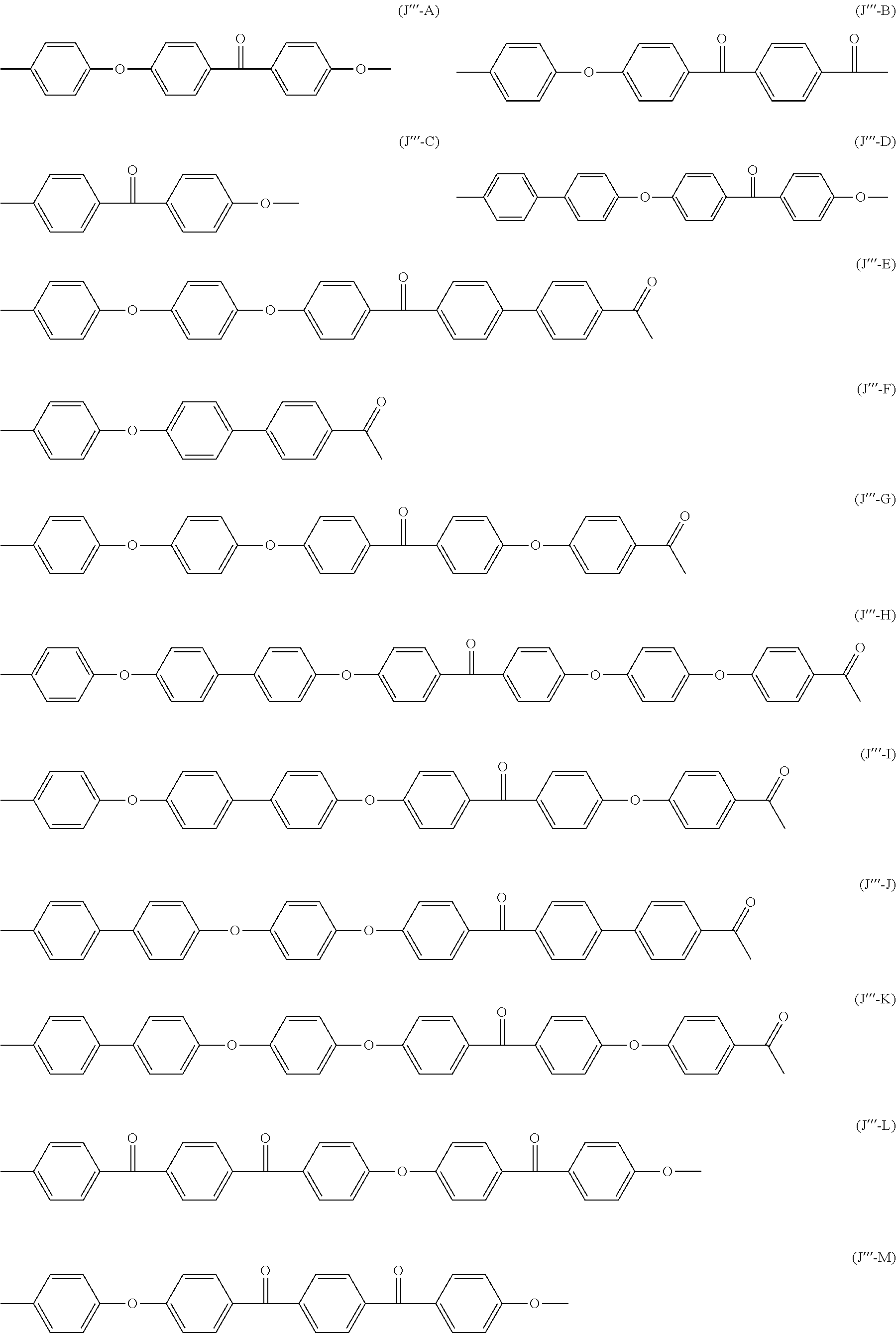

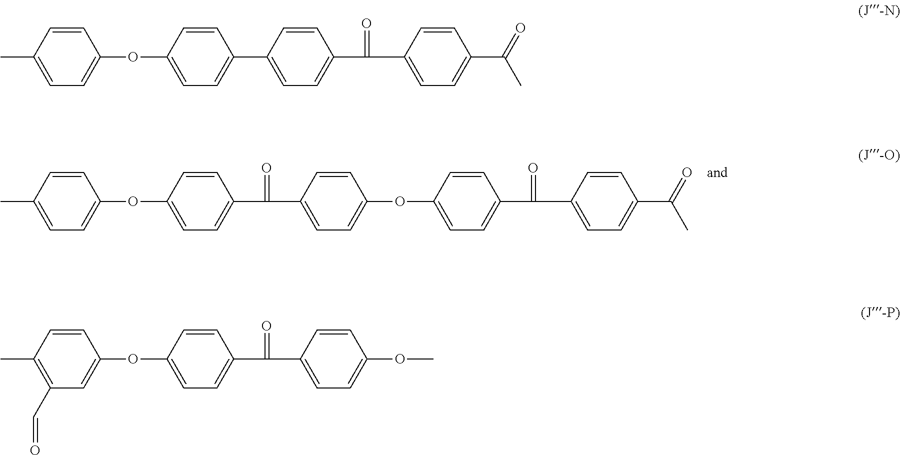

In some embodiments, recurring unit (Rₚₐₑ**) is represented by Formula (J′″-A) or (J′″-D).

In some embodiments in which the PAE polymer is a copolymer, recurring unit (Rₚₐₑ) can be represented by any one of formulae (J-A) to (J-P) and recurring unit (Rₚₐₑ*) can be respectively represented by any one of formulae (J″-A) to (J″-P). For example, in some embodiments, recurring unit (Rₚₐₑ) can be represented by Formula (J-A) and recurring unit (Rₚₐₑ*) can be represented by Formula (J″-A). As another example, in some embodiments, recurring unit (Rₚₐₑ) can be represented by Formula (J-D) and recurring unit (Rₚₐₑ*) can be represented by Formula (J″-D). In some embodiments, recurring unit (Rₚₐₑ) can be represented by any one of formulae (J′-A) to (J′-P) and recurring unit (Rₚₐₑ*) can be respectively represented by any one of formulae (J′″-A) to (J′″-P). For example, in some embodiments, recurring unit (Rₚₐₑ) can be represented by Formula (J′-A) and recurring unit (Rₚₐₑ*) can be represented by Formula (J′″-A). As another example, in some embodiments, recurring unit (Rₚₐₑ) can be represented by Formula (J′-D) and recurring unit (Rₚₐₑ*) can be represented by Formula (J′″-D).

In some embodiments in which the PAE polymer is a copolymer, the concentration of recurring unit (Rₚₐₑ*) can be from about 1 mol % to about 99 mol %, no more than about 1 mol %, no more than about 5 mol %, no more than about 10 mol %, no more than about 20 mol %, no more than about 30 mol %, no more than about 40 mol %, no more than about 50 mol %, no more than about 60 mol %, no more than about 70 mol %, no more than about 80 mol %, no more than about 90 mol %, no more than about 95 mol %, or no more than about 99 mol %.

In some embodiments, the chelating group M can be represented by a formula selected from the following group of formulae:

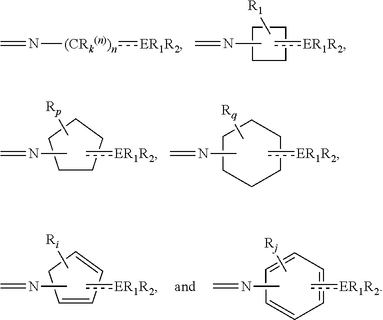

where each Rᵢ, Rⱼ, Rₖ, Rₗ, Rₚ, R_{q} are independently selected from the group consisting of a hydrogen, a halogen, an alkyl, an alkenyl, an alkynyl, an aryl, an ether, a thioether, a carboxylic acid, an ester, an amide, an imide, an alkali or alkaline earth metal sulfonate, an alkyl sulfonate, an alkali or alkaline earth metal phosphonate, an alkyl phosphonate, an amine and a quaternary ammonium; where i and j are independently selected integers from 0 to 4, where each k is an independently selected integer from 0 to 2; where 1 is an integer from 0 to 6; p is an integer from 0 to 8; q is an integer from 0 to 10 and n is and integer from 2 to 4. In some embodiments, n is selected from 1 to 3 or from 1 to 2. In some embodiments, the chelating group M can be represented by a formula selected from the following group of formulae:

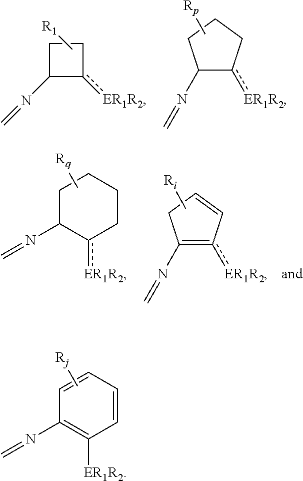

In some such embodiments, i, j, l, p, and q can be zero.

In some embodiments, the group [symbol] ER₁R₂ can be represented by a formula selected from the following group of formulae: =E, =ER₁, -ER₁ or -ER₁R₂. In some such embodiments, E can be selected from the group consisting of N, O and S. Examples of such embodiments include, but are not limited to, ═O, ═S, ═NR₁, ═PR₁R₂, —NR₁R₂, —PR₁R₂, —OR₁, and —SR₁. In some such embodiments, R1 and R2 can be independently represented by the formula —CH₃ or —(CH₂)_{n″}CH₃, where n″ is an integer from 1 to 10, from 1 to 5 or from 1 to 3. Excellent results were obtained where [symbol] ER₁R₂ was represented by the formula —SCH₃.

In some embodiments, the PAE chelating agent can be represented by a formula selected from the following group of formulae:

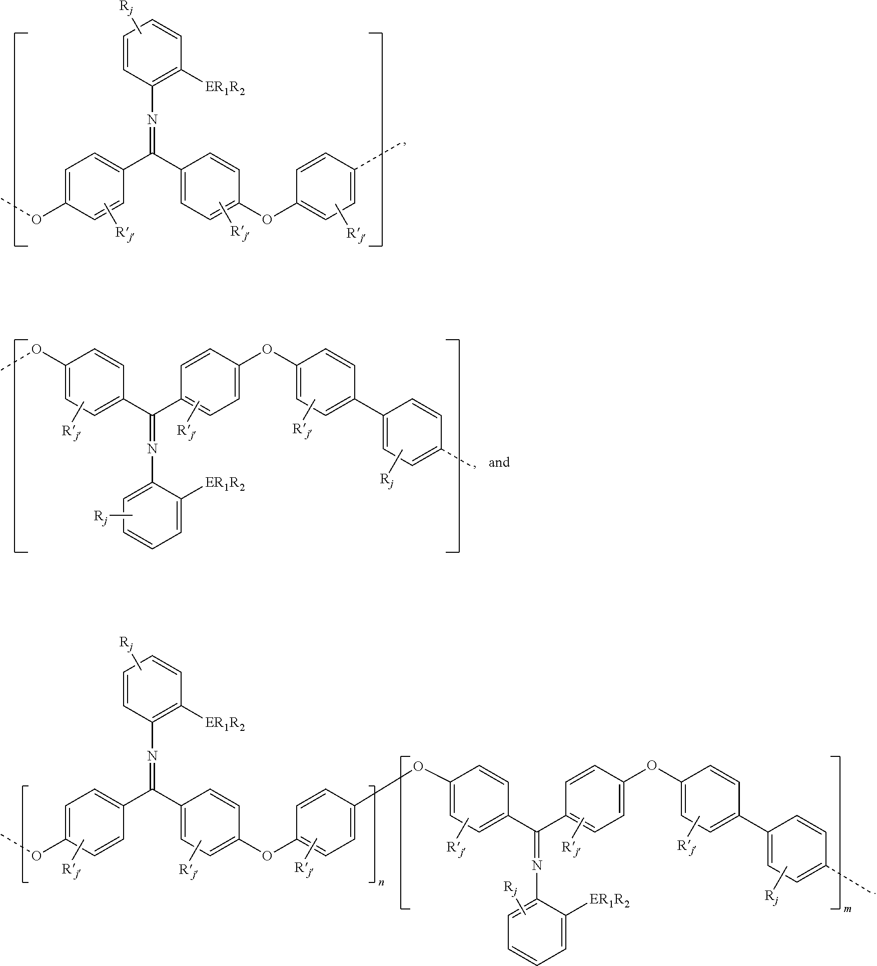

In some such embodiments, the PAE chelating agent can be represented by a formula selected from the following group of formulae:

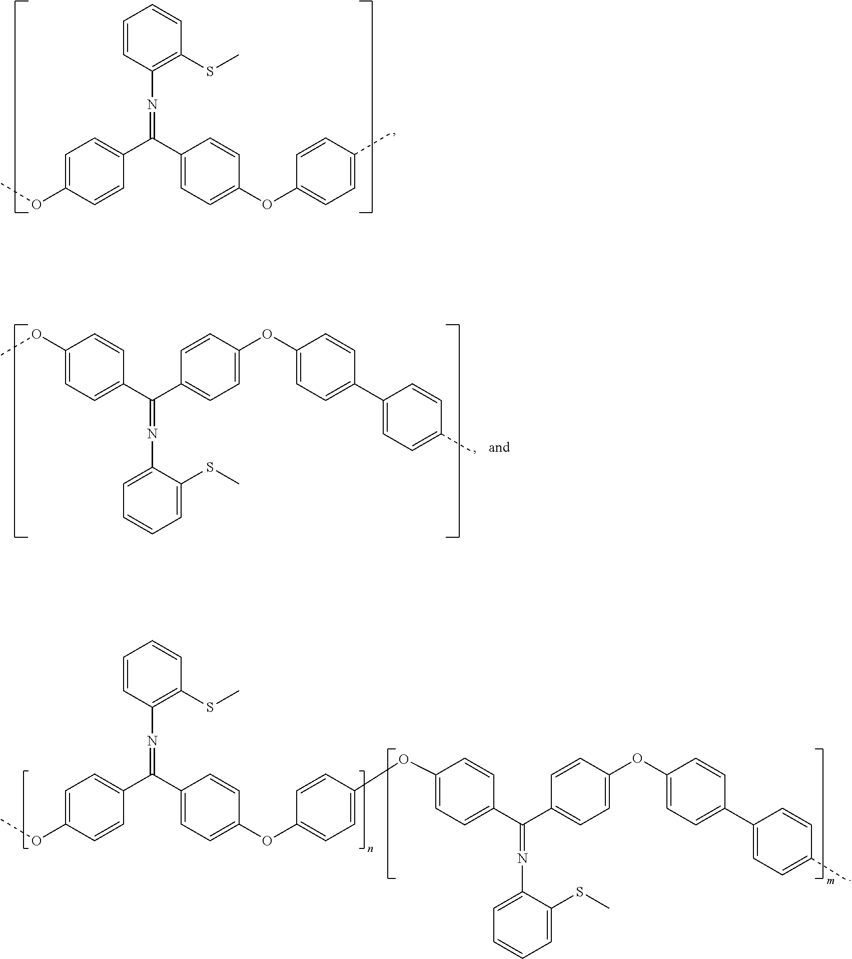

In some embodiments, the chelating agents can have a glass transition temperature of from about 50° C. to about 400° C., from about 100° C. to about 300° C., from about 130° C. to about 200° C. or from about 150° C. to about 180° C. In some embodiments, the chelating agents can have an onset decomposition temperature (“T_{d}”) of more than about 200° C., more than about 300° C., more than about 350° C., or more than about 400° C. A person of ordinary skill in the art will recognize additional glass transition temperature and onset decomposition temperature ranges within the explicitly disclosed ranges are contemplated and within the scope of the present disclosure.

The PAE polymers can have desirable ranges of average molecular weights. The average molecular weight of a polymer can be measured using the number average molecular weight (“Mn”),

$${M}_{n} = \frac{\sum {M}_{i} \cdot {N}_{i}}{\sum {N}_{i}} ,$$

where Mᵢ is the discrete value for the molecular weight of a polymer molecule in a sample and Nᵢ is the number of polymer molecules in the sample with molecular weight M. The average molecular weight of a polymer can also be measured using the weight average molecular weight (“Mn”),

$${M}_{w} = \frac{\sum {M}_{i}^{2} \cdot {N}_{i}}{\sum {M}_{i} \cdot {N}_{i}} ,$$

or the z-average molecular weight,

$${M}_{z} = \frac{\sum {M}_{i}^{3} \cdot {N}_{i}}{\sum {M}_{i}^{2} \cdot {N}_{i}^{2}} .$$

In general, the weight average molecular weight accounts for the fact that the polymer molecules in the composition have different weights and the z-average molecular weight is further biased (e.g., more sensitive to) by higher molecular weight polymers in the composition. A measure of the width of the distribution of molecular weights can be given by the polydispersity index (“PDI”), where PDI=M_{w}/Mₙ. Mₙ, M_{w} and M_{z} can be measured using gel permeation chromatograph (“GPC”), which separates polymer molecules based on their respective sizes (e.g., hydrodynamic radius or radius of gyration) and using a porous medium.

The chelating agents described herein can have a number average molecular weight of at least about 1,000 g/mol, at least about 2,500 g/mol, at least about 5,000 g/mol, at least about 7,500 g/mol or at least about 10,000 g/mol. In some such embodiments, the chelating agents can have a number average molecular weight of no more than about 60,000 g/mol, no more than about 50,000 g/mol, no more than about 40,000 g/mol or no more than about 30,000 g/mol. The chelating agents described herein can have a weight average molecular weight of at least about 10,000 g/mol, at least about 20,000 g/mol or at least about 30,000 g/mol. In some such embodiments, the chelating agents can have a weight average molecular weight of no more than about 500,000 g/mol, no more than about 400,000 g/mol, no more than about 300,000 g/mol, or no more than about 280,000 g/mol. The chelating agents described herein can have a z-average molecular weight of at least about 50,000 g/mol, at least about 100,000 g/mol or at least about 150,000 g/mol. In some such embodiments, the chelating agents can have a z-average molecular weight of no more than about 1,000,000 g/mol, no more than about 900,000 g/mol or no more than about 800,000 g/mol. The chelating agents can have a PDI of at least about 1.0, at least about 1.2 or at least about 1.5. In some such embodiments, the chelating agent can have a PDI of no more than about 60, no more than about 50, no more than about 40 or no more than about 30. A person of ordinary skill in the art will recognize additional ranges of Mₙ, M_{w}, M_{z} and PDI within the explicitly disclosed ranges are contemplated and within the scope of the present disclosure.

In some embodiments, the PAE chelating agent can have a concentration of at least about 1 wt. %, at least about 5 wt. %, at least about 10 wt. %, at least about 20 wt. %, at least about 30 wt. %, at least about 40 wt. %, at least about 50 wt. %, at least about 60 wt. %, at least about 70 wt. %, at least about 80 wt. %, at least about 90 wt. %, at least about 95 wt. %, or at least about 99 wt. %, relative to the total weight of the PAE adhesive composition. In some embodiments, the PAE adhesive composition can consist essentially of the PAE chelating agent. A person of ordinary skill in the art will recognize additional ranges within the explicitly disclosed ranges are contemplated and within the scope of the present disclosure. In embodiments in which the PAE adhesive composition includes more than one PAE chelating agent, the total concentration of the PAE chelating agents can be given as described above. In other embodiments in which the PAE adhesive composition includes more than one PAE chelating agent, the concentration of each of the PAE chelating agents can be independently selected from the ranges given above.

In some embodiments, the PAE adhesive composition can optionally include one or more PAEK polymers. As used herein, a PAEK polymer refers to a polymer containing at least 50 mol % recurring unit (R_{PAEK}) including an Ar—C(═O)—Ar′. In some embodiments, the PAEK polymer can have at least 60 mol %, at least 70 mol %, at least 80 mol %, at least 90 mol %, at least 95 mol % or at least 99 mol % recurring unit (R_{PAEK}). A person of ordinary skill in the art will recognize additional (R_{PAEK}) concentration ranges within the explicitly disclosed ranges are contemplated and within the scope of the present disclosure. In some embodiments, (R_{PAEK}) can be represented by a formula from the group consisting of Formula (J″-A) to Formula (J″-P) and Formula (J′″-A) to Formula (J′″-P). In some embodiments, the PAEK polymer can further comprise repeat unit (R_{PAEK}^{*}) distinct from (R_{PAEK}). In some such embodiments, R_{PAEK}) can be represented by a formula from the group consisting of Formula (J″-A) to Formula (J″-P) and Formula (J′″-A) to Formula (J′″-P). In some embodiments in which the PAEK polymer contains repeat units (R_{PAEK}) and (R_{PAEK}^{*}), the (R_{PAEK}*) concentration can be at least 1 mol %, at least 5 mol % at least 10 mol %, at least 20 mol %, at least 30 mol %, at least 40 mol %, or no more than about 50 mol %. A person of ordinary skill in the art will recognize additional (R_{PAEK}*) concentration ranges within the explicitly disclosed ranges are contemplated and within the scope of the present disclosure.

In some embodiments, the total concentration of PEAK polymers can be at least about 1 wt. %, at least about 5 wt. %, at least about 10 wt. %, at least about 20 wt. %, at least about 30 wt. %, at least about 40 wt. %, at least about 50 wt. %, at least about 60 wt. %, at least about 70 wt. %, at least about 80 wt. %, at least about 90 wt. %, at least about 95 wt. %, or at least about 99 wt. %, relative to the total weight of the PAE adhesive composition. A person of ordinary skill in the art will recognize additional total PEAK polymer concentration ranges within the explicitly disclosed ranges are contemplated and within the scope of the present disclosure. In some embodiments in which the PAE adhesive composition include more than one PAEK polymers, each PAEK polymer can have an independently selected concentration from the ranges described above.

### The Poly(Aryl Ether) Chelating Agent: Synthesis

The PAE chelating agents can be formed using traditional PAEK synthesis approaches that are specifically adapted for the synthesis of the PAE polymers described herein. In some embodiments, the PAE chelating agents can be synthesized by the polycondensation of monomers used in traditional PAEK synthesis, where the monomers are functionalized with a chelating group. In some embodiments, the PAE chelating agents can be synthesized by functionalizing a PAEK polymer with chelating groups. In some embodiments, the chelating groups can be synthesized using a Schiff base reaction. The synthetic approaches described herein can allow for resulting PAE chelating agents with a tunable range of average molecular weights.

In some embodiments, the PAE chelating agents can be formed using traditional PAEK synthesis approaches which are specifically adapted for the synthesis of the PAE chelating agents described herein. Traditional PAEK synthesis approaches generally involve the polycondensation of a di-halo ketone monomer and a diol monomer. Such traditional approaches are discussed in U.S Pat. Nos. 3,953,400; 3,956,240; 3,928,295; and 4,176,222, all of which are incorporated herein by reference. In some embodiments, the PAE chelating agents described herein can be synthesized by first functionalizing the di-halo ketone monomer with a chelating group and, subsequently, reacting the functionalized di-halo monomer with the diol monomer. The di-halo ketone monomer can be functionalized using a Schiff base reaction between the diol-halo ketone monomer and the amine form of the chelating agent.

The above-mentioned synthetic approach can help to promote control of the composition and molecular weight of the resulting PAE chelating agent. For example, the functionalized di-halo monomer can be purified prior to polycondensation with the diol monomer. In such instances, variation in the composition of the PAE chelating agents can be at least partially mitigated due to the decreased variation in the composition of the monomer species. As another example, in general, increased reaction temperatures and reaction times during polycondensation result in chelating agents having higher molecular weights. Correspondingly, a person of ordinary skill in the art will be able to select appropriate polycondensation reaction parameters to obtain a desired molecular weight, based upon the present disclosure.

The aforementioned synthesis approach can be represented by the following scheme:

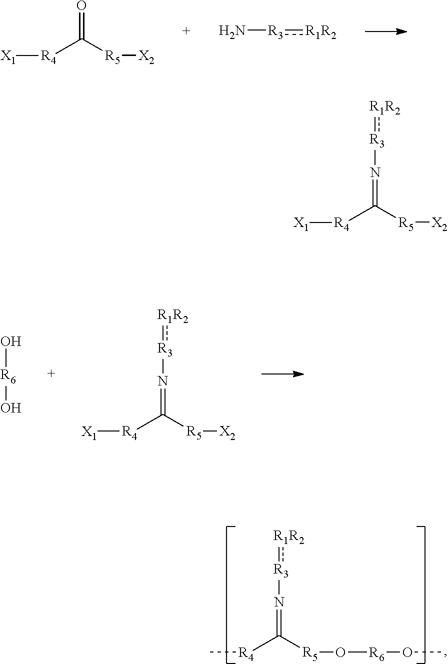

where R₄-R₆ are independently selected from the group consisting of an alkyl, an alkenyl, an alkynyl, an aryl, an ether, a thioether, a carboxylic acid, an ester, an amide, an imide, an amine, and any combination thereof, and where X₁ and X₂ are independently selected halogen atoms. In some embodiments, R₆ can be selected from the group consisting of a hydroquinone, a bisphenol-A, a bisphenol-S, a biphenol, a terphenol, and a naphthol.

For example, a chelating agent represented by Formula (J-A) can be synthesized as follows:

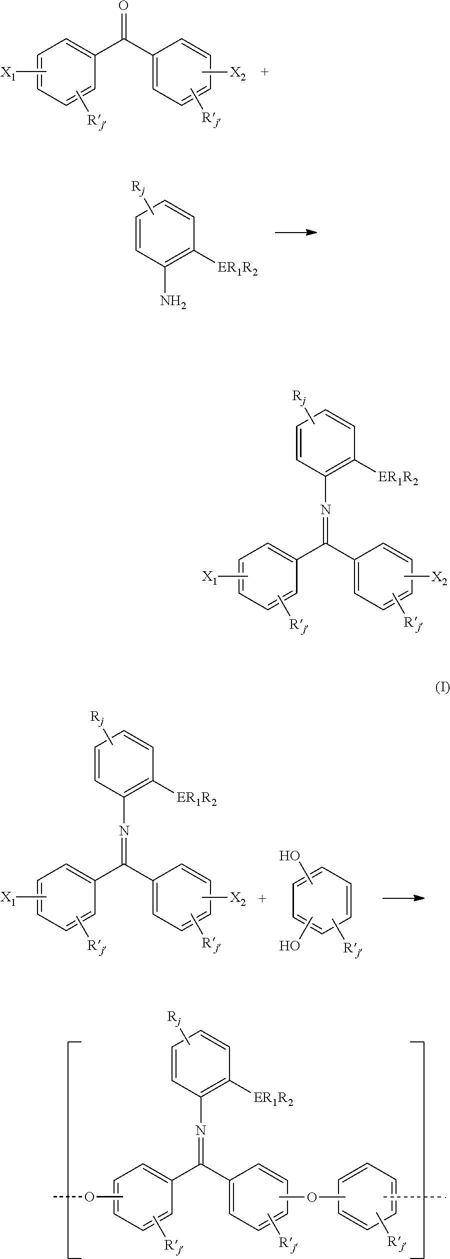

As another example, a chelating agent represented by Formula (J-D) can be synthesized as follows:

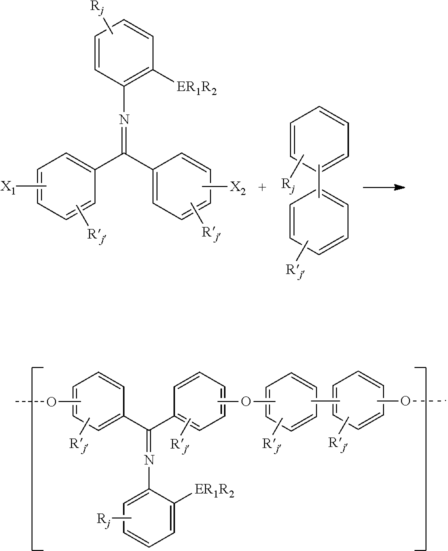

Based on the present disclosure, a person of ordinary skill in the art will know how to apply the above-mentioned synthesis approaches to chelating agents represented by the Formulae (J-A) to (J-P) and (J′-A) to (J′-P) above and copolymers thereof, as well as to other chelating agents described herein.

In another synthetic approach, a PAEK polymer can be initially synthesized by polycondensation of a di-halo ketone monomer and a diol monomer and, subsequently, the resulting PAEK polymer can be functionalized with a chelating group to form a PAE chelating agent. In some embodiments, such an approach can be desirable because of the reduced number of synthetic steps. In particular, PAEK polymers are widely commercially available and, therefore, a one-step approach can be used to synthesize the PAE chelating agents. Commercial sources of PAEK polymers are available under the trade name KetaSpire® PEEK from Solvay Specialty Polymers USA, L.L.C (Alpharetta, Ga., USA). The synthesis approach can be represented by the following scheme:

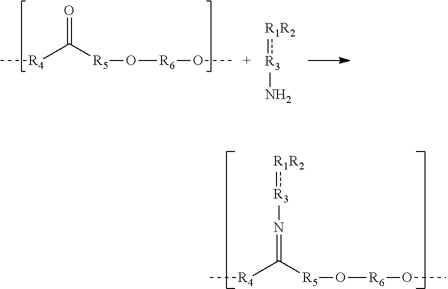

Monomers used for PEEK synthesis can be functionalized and subsequently reacted to form the PAE chelating agents. For example, a PAE chelating agent represented by Formula (J-A) can be synthesized according to the following scheme:

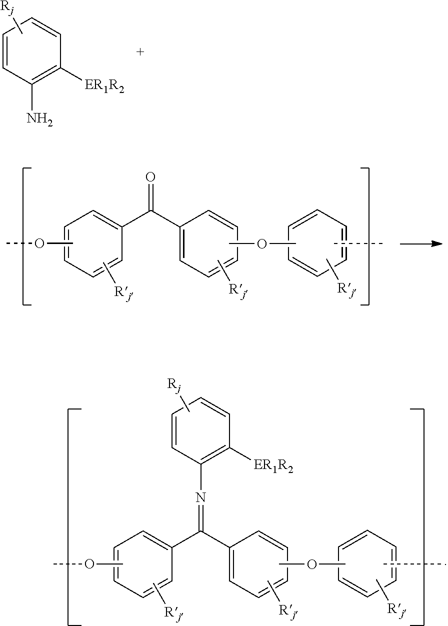

As another example, a PAE chelating agent represented by Formula (J-D) can be synthesized according to the following scheme:

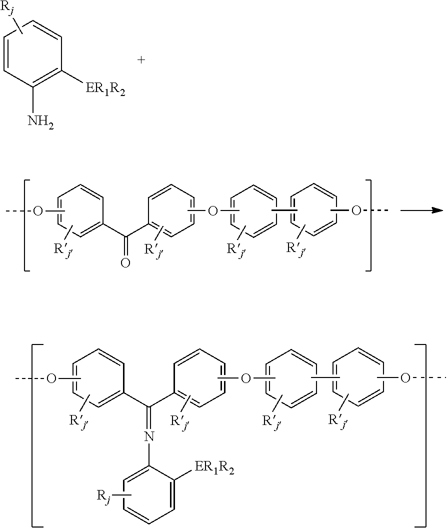

Based on the present disclosure, a person of ordinary skill in the art will know how to apply the above-mentioned synthesis approach to chelating agents represented by the Formulae (J-A) to (J-M) and (J′-A) to (J′-M) above and copolymers thereof, as well as to other chelating agents described herein.

### Polymer-Metal Junctions and Fabrication Methods

The PAE adhesive compositions can be molded over metal substrates or portions thereof. In some embodiments, the metal can include, but is not limited to, aluminum, stainless steel, copper, nickel, titanium, blends thereof, and alloys thereof. In some embodiments, the PAE adhesive composition can form the outermost layer of polymer-metal junction. In some embodiments, the PAE adhesive composition can be disposed between the metal substrate of the junction and a polymer composition distinct from the PAE adhesive compositions. In some embodiments, one or more adhesion promoters can be disposed between the PAE adhesive composition and the metal substrate of the polymer-metal junction.

In some embodiments, the polymer-metal junction can have a PAE adhesive composition as the outermost polymer layer on the metal substrate. Of course, in some embodiments, the PAE composition can form a structure, for example, at least a portion of a mobile electronic device component, as discussed further below. In some embodiments, the PAE adhesive composition can contact at least a portion of the metal substrate.

In some embodiments, the PAE adhesive composition can be disposed between at least a portion of the metal substrate and at least a portion of a polymer composition distinct from the PAE adhesive composition. In such embodiments, the PAE adhesive composition can promote adhesion between the distinct polymer composition and the metal substrate of the polymer-metal junction. In some embodiments, the distinct polymer composition can form a structure, for example, at least a portion of a mobile electronic device component. In some embodiments, the polymer composition distinct from the PAE composition can include a PAE polymer distinct from the PAE chelating agent. As used herein a PAE polymer refers to any polymer having at least 50 mol% recurring unit (R_{PE}) including at least one arylene group and at least one ether group (—O—). In some embodiments, the PAE polymer can have at least 60 mol %, at least 70 mol %, at least 80 mol %, at least 90 mol %, at least 95 mol % or at least 99 mol % recurring units (R_{PE}).

In some embodiments, the PAE polymer can be a PAEK polymer. A PAEK polymer refers to any polymer including at least 50 mol % recurring unit (R_{PAEK}) including at least one Ar—C(═O)—Ar′ group, with Ar and Ar′, equal to or different from each other, being aromatic groups. In some embodiments, the PAEK polymer can have at least 60 mol %, at least 70 mol %, at least 80 mol %, at least 90 mol %, at least 95 mol % or at least 99 mol % recurring unit (R_{PAEK}). In some embodiments, recurring unit (R_{PAEK}) can be represented by a formula selected from the group of formulae consisting of (J″-A) to (J″-O), (J′″-A) to (J′″-O) or any combination thereof. In some embodiments, the PAEK polymer can additionally include recurring units (R*_{PAEK}), distinct from recurring unit (R*_{PAEK}). In some such embodiments, recurring unit (R*_{PAEK}) can be represented by a formula selected from the group of formulae consisting of (J″-A) to (J″-O), (J′″-A) to (J′″-O) or any combination therefor. In embodiments having recurring unit (R*_{PAEK}), distinct from recurring unit (R*^{PAEK}), the PAEK polymer can have at least 10 mol %, at least 20 mol %, at least 30 mol %, at least 40 mol % or at least 50 mol % recurring unit (R*^{PAEK}). Desirable PAEK polymers include, but are not limited to, those described in U.S. Pat. No. 8,946,341 to Kwan et al., filed Apr. 9, 2013 and entitled “Polymer Compositions Comprising Poly(Arylether Ketone)s and Graphene Materials,” incorporated herein by reference.

The polymer-metal junctions described above can be fabricated by molding the PAE adhesive compositions onto the metal substrate of the polymer-metal junction. Similarly, the distinct polymer composition can also be molded over the PAE adhesive compositions. Molding techniques include, but are not limited to, solution coating (e.g., dip coating, blade coating, spin coating and the like) powder coating, injection molding and compression molding. In dip coating and powder coating, a polymer solution is formed from an appropriate solvent and about 1 wt. % to about 30 wt. % of the polymer. In dip coating, at least a portion of a substrate is dipped into the solution to coat the substrate. In blade coating, the solution is disposed on at least a portion of a substrate and a doctor blade is passed across the substrate surface at a selected height to remove excess solution and form a uniform coating. In some embodiments, the selected height can be from about 1 mil (1 mil=0.001 in.) to about 50 mil, from about 1 mil to about 25 mil, or from about 1 mil to about 2 mil. A person of ordinary skill in the art will recognize additional selected heights within the explicitly disclosed ranges are contemplated and within the scope of the present disclosure. In both dip coating and blade coating, the coated substrates are dried to cure the coating. In some dip coating and blade coating embodiments, the substrate can be heated prior to deposition of the polymer solution. In injection molding and compression molding, a substrate is placed in a mold and the polymer composition fills the mold, around at least a portion of the substrate. In injection molding, a plunger (e.g. a screw) to force a molten polymer composition into a mold cavity and around at least a portion of substrate. In compression molding, the polymer composition is placed in an open mold along with the substrate and, subsequently, the mold is closed, which compresses the polymer composition against at least a portion of the substrate and the inner walls of the mold.

In some embodiments, a polymer composition can be molded onto a substrate by powder coating. In general, powder coating involves a solventless deposition of a polymer composition onto a substrate. Because there is no solvent, thicker coatings can be formed while still maintaining a uniform coating. In powder coating, a powder of the polymer composition is formed. In some embodiments, the powder has an average primary particle size of no more than about 100 microns (“μm”), no more than about 60 μm, no more than about 45 μm, or no more than about 40 μm. In some embodiments, the powder has an average primary particle size of at least about 10 μm, at least about 15 μm, at least about 20 μm or at least about 25 μm. A person of ordinary skill in the art will recognize additional primary particle size ranges within the explicitly disclosed ranges are contemplated and within the scope of the present disclosure. The polymer composition is then applied to the metal substrate by electrostatic spraying. In electrostatic spraying, an electrostatic nozzle (e.g. electrostatic gun) applies a positive electric charge to the polymer composition particles in the powder, which is sprayed towards the grounded substrate. The PAE adhesive composition and optional distinct polymer composition can be coated by independently selected methods as described above.

Notwithstanding the particular deposition approach, in some embodiments, the metal substrate can be cleaned and/or treated with an adhesion promoter prior to deposition of the PAE adhesive composition. Removal of oil, dirt, oxides and other non-desirable compositions from the surface of a metal substrate can help to increase the adhesion of the PAE adhesive composition to the substrate. Cleaning can include, but is not limited to, cleaning with an appropriate solvent (e.g., acetone); vapor degreasing (e.g., tricholorethane vapour); abrasion with silicon carbide abrasive, surface anodization (e.g., according to the ASTM D3933-2010 standard), acid etching, alkaline etching and any combination of one or more thereof. In some embodiments, surface anodization can be particularly desirable. In such embodiments, the surface anodization can create a porous substrate surface which can help to promote adhesion between the PAE adhesive composition and the metal substrate. Specifics of some pre-deposition cleaning methods are discussed in the Examples below. In some embodiments, one or more adhesion promoters can be used as a primer prior to deposition of the PAE adhesive composition. In such embodiments, the adhesion promoter can increase the adhesive strength (e.g., peel strength and/or shear strengths) of the bond between the PAE adhesive composition and the metal substrate. Adhesion promoters can include, but are not limited to, zirconium (IV) tetra-n-butoxide; titanium (IV) di-iso-propoxide bis(acetylacetonate); 2,2,4,4-tetramethyl-1,3-cyclobutanediol polymer with DFBP; (3 -isocyanatopropyl)triethoxysilane; (3-glycidoxypropyl)triethoxysilane; 3-aminobenzoic acid with Cymel® 303 LF resin; 2,5-dihydroxybenzoic acid polymer with 4,4′-difluorobenzophenone (“DFBP”); polyisosorbideketone; and polysulfoneisosorbide. Other adhesion promoters are demonstrated in the Examples below. Excellent results were obtained with zirconate adhesion promoters (e.g., zirconium (IV) tetra-n-butoxide; titanium).

In some embodiments, at least a portion of the PAE adhesive composition can be converted to the corresponding PAEK polymer by hydrolytic cleavage of the imine bond. In such embodiments, the PAE chelating agent can be heated in the presence of steam or water to cleave the imine bond of the chelating and form a carbonyl group. For example, a PAE chelating agent having recurring unit (R_{PAE}) represented by a formula selected from the group of formulae (J-A)-(J-P) and (J′-A) to (J′-P) can be converted to a PAEK polymer having a formula selected from the group of formula (J″-A)-(J″-P) and (J′″-A) to (J′″-P), respectively, by heating the PAE chelating agent in the presence of steam or water. In some such embodiments, the amount of the PAE chelating agent converted into the corresponding PAEK polymer can be selected by appropriate selection of the heating temperature and time. For example, where the PAE chelating agent forms a layer, the heating time and temperature can be selected such that only a selected portion of the PAE chelating agent layer is converted to the corresponding PAEK polymer. In such an example, the thickness of the corresponding PAEK composition can be selected based on the time and temperature of heating.

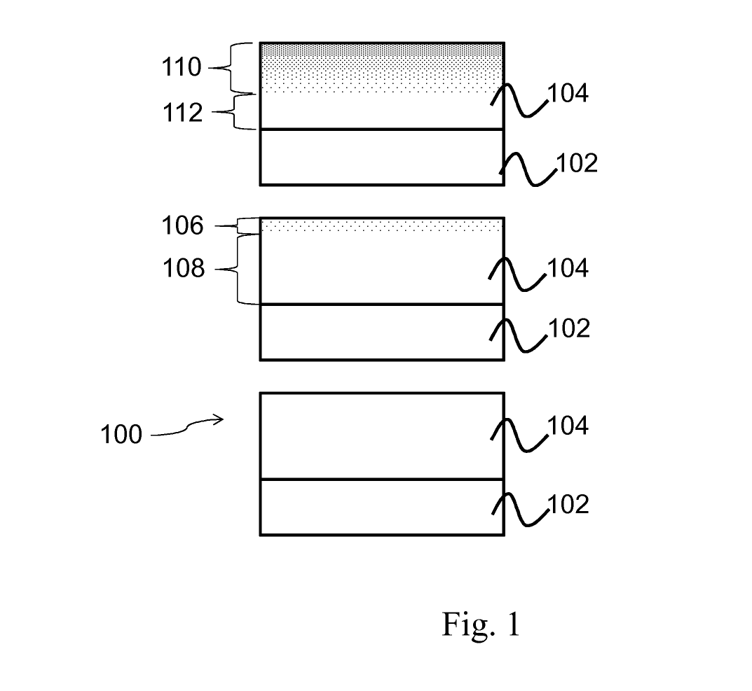

Furthermore, in some embodiments, the resulting PAEK polymer can protect the underlying PAE adhesive composition from further hydrolysis. In particular, as the amount of PAE chelating agent converted to the corresponding PAEK polymer increases, it can become increasingly difficult to convert more of the PAE chelating agent to the corresponding PAEK polymer because the PAEK polymer acts as a barrier against further hydrolytic conversion of the imine bond. In such embodiments, the thickness of the PAE adhesive compositions can be empirically selected such that the formed PAEK composition provides a chemically resistant coating to the underlying PAE adhesive composition. FIG. 1 is a schematic representation of one embodiment of a polymer-metal junction prior to thermal treatment (bottom panel), after thermal treatment for time t₁ (middle panel) and after thermal treatment at time t₂>t₁ (top panel). Referring to FIG. 1, polymer-metal junction 100 includes metal substrate 102 and polymer composition 104. Prior to thermal treatment, polymer composition 104 consists of a PAE adhesive composition. After initial thermal treatment, portion 106 of polymer composition 104 is converted to the corresponding PAEK polymer, as denoted by the dotted pattern in the middle panel of FIG. 1, while portion 108 of polymer composition 104 remains a PAE adhesive composition. After further thermal treatment, a portion 110 (thicker than portion 106) of polymer composition 104 is converted into the corresponding PEAK polymer, as denoted in the top panel of FIG. 1, while portion 112 (thinner than portion 108) remains a PAE adhesive composition. In some embodiments, further thermal treatment of polymer-metal junction 100 can provide further conversion of polymer composition 104 to the corresponding PEAK polymer. In other embodiments, portion 110 can protect portion 112 from further hydrolytic conversion during thermal treatment.

Based upon the disclosure herein, a person of ordinary skill in the art will know how to empirically determine an appropriate heating temperature, heating time and PAE adhesive composition thickness based upon the particular application setting. In some embodiments, the heating temperature can be from about 100° C. to about 300° C., to about 250° C., to about 200° C. or to about 150° C. In some embodiments, the heating time can be at least about 1 minute, at least about 1 hr., at least about 2 hr., at least about 3 hr., at least about 4 hr. or at least about 5 hr. In some such embodiments, the heating time can be no more than about 50 hours, no more than about 40 hours, no more than about 30 hours, no more than about 20 hours or no more than about 15 hours. In some embodiments in which the PAE adhesive composition forms a layer on a substrate, the portion of the PAE composition converted to the corresponding PAEK polymer can have depth from the surface of the PAE adhesive composition layer of at least about 0.01 micrometers (“μm”), at least about 0.05 μm, or at least about 0.1 μm. In some such embodiments, the portion of the PAE adhesive composition converted to the corresponding PAEK polymer can have a depth of no more than about 10 μm, no more than about 8 μm, no more than about 6 μm or no more than about 5 μm. A person of ordinary skill in the art will recognize additional ranges of heating times, temperatures and conversion depths within the explicitly disclosed ranges are contemplated and within the scope of the present disclosure.

### Articles

In some embodiments, the PAE adhesive compositions described herein can be desirably incorporated into a mobile electronic device component as part of a polymer-metal junction, as described in detail above. Of course, the mobile electronic device component can be incorporated into a mobile electronic device. As used herein, a “mobile electronic device” refers to an electronic device that is intended to be conveniently transported and used in various locations. A mobile electronic device can include, but is not limited to, a mobile phone, a personal digital assistant (“PDA”), a laptop computer, a tablet computer, a wearable computing device (e.g., a smart watch and smart glasses), a camera, a portable audio player, a portable radio, a global position system receiver, and portable game console. For clarity, reference to “device component(s)” includes a reference to “mobile electronic device component(s),” unless explicitly stated otherwise.

In some embodiments, at least a portion of the device component can be exposed to the external environment of the mobile electronic device (e.g., at least a portion of the device component is in contact with the environment external to the mobile electronic device). For example, at least a portion of the device component can form at least a portion of the external housing of the mobile electronic device. In some such embodiments, the component can be a full or partial “frame” around the periphery of the mobile electronic device, a beam in the form of a lattice work, or a combination thereof. As another example, at least a portion of the device component can form at least a portion of an input device. In some such embodiments, a button of the electronic device can include the device component. In some embodiments, the device component can be fully enclosed by the electronic device (e.g., the component is not visible from an observation point external to the mobile electronic device).

In some embodiments, the device component can include a mounting component with mounting holes or other fastening device, including but not limited to, a snap fit connector between itself and another component of the mobile electronic device, including but not limited to, a circuit board, a microphone, a speaker, a display, a battery, a cover, a housing, an electrical or electronic connector, a hinge, a radio antenna, a switch, or a switchpad. In some embodiments, the mobile electronic device can be at least a portion of an input device

The components of the mobile electronic device can be fabricated using methods well known in the art. For example, the device components can be fabricated by methods including, but not limited to, injection molding, blow molding or extrusion molding. In some embodiments, the PAE adhesive compositions can be formed into pellets (e.g., having a substantially cylindrical body between two ends) by methods known in the art including, but not limited to, injection molding. In some such embodiments, device components can be fabricated from the pellets.

In other embodiments, the PAE adhesive compositions can be used as protective coatings to prevent corrosion of metal articles or to impart chemical resistance. For example, metals structural components in aquatic environments such as those used in ships, submarines, drilling rigs, or docks can be protected by first coating with a PAE adhesive composition and optionally hydrolyzing the surface, as described in detail above. Metal articles exposed to the weather can be protected by first coating with a PAE adhesive composition and optionally hydrolyzing the surface, as described in detail above. For example, metal components on the exterior of buildings, automobiles, or recreational equipment. In some embodiments, the PAE adhesive compositions can be used as wire coatings. In some such embodiments, the PAE compositions can be especially desirable in down-hole drilling applications. For example, as a wire coating under down-hole conditions (e.g. 150° C. brine), a PAE adhesive composition wire coating can form a surface PAE polymer layer in-situ, with the corresponding PAE chelating agent underneath to help maintain an adhesive bond to the wire substrate.

### EXAMPLES

The following examples demonstrate the synthesis, characterization and adhesive performance of adhesive compositions containing PAE chelating agents.

In the examples below, molecular weight was determined using GPC analysis with methylene chloride as the eluent and referenced to the polystyrene standard. GPC analysis was performed with a Waters 2695 separations module with a Waters 2487 Dual Wavelength UV detector (Milford, Mass., USA). Differential scanning calorimetry (DSC) was performed to determine glass transition temperature (“T_{g}”). Thermogravimetric analysis (TGA) was used to determine onset degradation temperature, T_{d5}. T_{d5} is the temperature at which the polymer sample lost 5 wt. % of its mass. Glass transition temperatures were determined by DSC using a TA Instruments DSC Q20 differential scanning calorimeter (New Castle, Del., USA) with a temperature ramp rate of 20° C./min. T_{d5} was determined by TGA using a TA Instruments TGA Q500 thermogravimetric analyzer with a temperature ramp rate of about 10° C./min. Structural analysis was performed using ¹HNMR and ¹³CNMR. The inherent viscosity was measured by forming a 0.5 g/deciliter (“dL”) polymer solution with N-methyl-2-pyrrolidone (“NMP”) solvent at 30 ° C. and using a Canon-Fenske size 100 glass viscometer tube.

To demonstrate adhesive performance, lap shear strength and peel strength were tested. In each instance, a poly(ether ether ketone) (“PEEK”) polymer composition, a PAE adhesive composition, and/or one or more adhesion promoters were overmolded or solution coated onto a metal substrate (stainless steel or aluminium). In each case, the PEEK polymer formed the outer-most coating. The PEEK polymer used is commercially available under the trade name KetaSpire® PEEK KT-820 GF30 from Solvay Specialty Polymers USA, L.L.C. (Alpharetta, Ga., USA). In samples containing one or more adhesion promoters, the adhesion promoter formed the inner-most coating with the PAE adhesive agent disposed on top the one or more adhesion promoters. In samples free of adhesion promoters, the PAE adhesive composition was disposed directly on the substrate, forming the innermost layer.

Overmolding consisted of powder coating, injection molding or compression molding. For powder coated compositions, the composition was cryogenically milled with liquid nitrogen to form a powder and, subsequently, the powder was passed through a particle classifier such that the filtered powder had a maximum primary particle diameter of no more than about 45 μm. The filtered powder was then electrostatically coated onto the substrate. Following powder coating, the coated sample was cured overnight at 265° C. For compression molding, the composition was compression molded at 400° C. on the substrate with an applied force of about 4,500 lb. For solution coated compositions, the substrate was coated using dip coating or blade coating. Dip coating was performed by dipping the substrate in a 5 wt. % solution of polymer composition in CHCl₃ and drying the coating with a hot air gun. Blade coating was performed by first forming a 10 wt. % solution of the polymer compositions in NMP. The solution was then deposited onto a substrate which was held at 100° C. Excess solution was removed using a doctor blade having a 10 millimeter (“mm”) gap between the edge of the blade and the surface of the substrate. The substrate was held at 100° C. after deposition for about 10 minutes to allow the coating to dry. The coated substrate was then cured by drying in a vacuum oven at 120° C. for about 48 hr.

### Example 1

### Synthesis of Functionalized Monomers: DFPBCH and HQCH

The following example demonstrates the syntheses of monomers containing chelating groups. In particular, this example demonstrates the synthesis of 1,1-bis(4-fluorophenyl)-N-(2-(methylthio)phenyl)methanamine (“DFPBCH”) and 2-(((2-(methylthio)phenyl)imino)methyl)benzene-1,4-diol (“HQCH”) according to the following Schiff base reaction schemes, respectively:

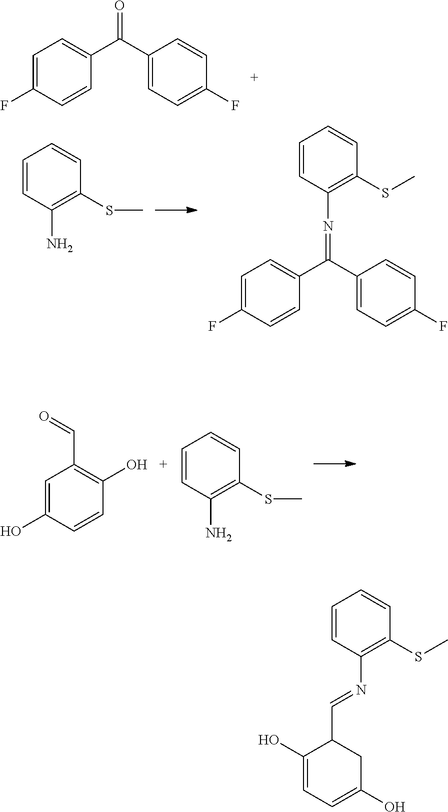

Synthesis of the DFPBCH monomer was demonstrated using two different synthesis approaches, each approach using a different set of reaction and purification conditions. The chelating group was synthesized by adding 4,4′-difluorobenzophenone (“DFBP”), 2-methylthioaniline and xylene were added to a 500 ml, 3-neck round bottom flask fitted with a Dean Stark trap, mechanical stirrer and nitrogen inlet/outlet. The mixture was heated to 60° C. and, subsequently, p-toluene sulfonic acid (“pTsOH”) was added to the mixture and the mixture was refluxed. After refluxing, the mixture was cooled to room temperature and the solids were filtered and washed with 2×100 mL portions of methanol. The resulting solids were recrystallized in ethanol one or two times. Recrystallization consisted of forming a suspension of the solids in ethanol, stirring the suspension at 60° C. and cooling the suspension at 8° C. in a refrigerator for about 14 hours. After refrigeration, the solids in the suspension were then filtered and washed with ethanol. Following recrystallization, the collected solids were dried in a vacuum oven for 6 hours. In the second approach, the dried product was recrystallized and vacuum dried for a second time as previously described. The reaction and purification conditions of each approach are displayed in Table 1 below:

TABLE 1

| | | | | | | # of | | |
|---|---|---|---|---|---|---|---|---|
| | Amount of Starting Materials | | | Reflux | | Recrystallizations | | |
| | (g (mol)) | | | Conditions | | Before | After | Drying |
| Approach | | 2- | | Time | Temp. | 1^{st} | 1^{st} | Temp. |
| No. | DFBP | methylthioaniline | pTsOH | (hr.) | (° C.) | Drying | Drying | (° C.) |
| 1 | 37.1 | 25.0 | 1.0 | 8 | 140 | 1 | 0 | 70 |
| | (0.170) | (0.180) | (0.005) | | | | | |
| 2 | 74.12 | 50.0 | 2.0 | 15 | 140 | 2 | 1 | 80 |
| | (0.34) | (0.34) | (0.01) | | | | | |

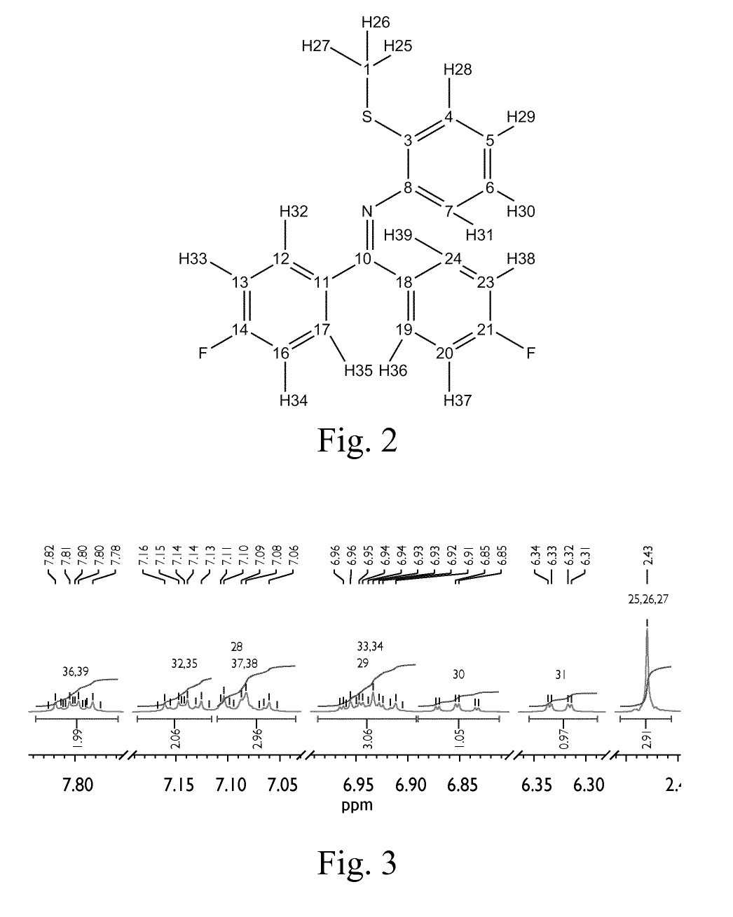

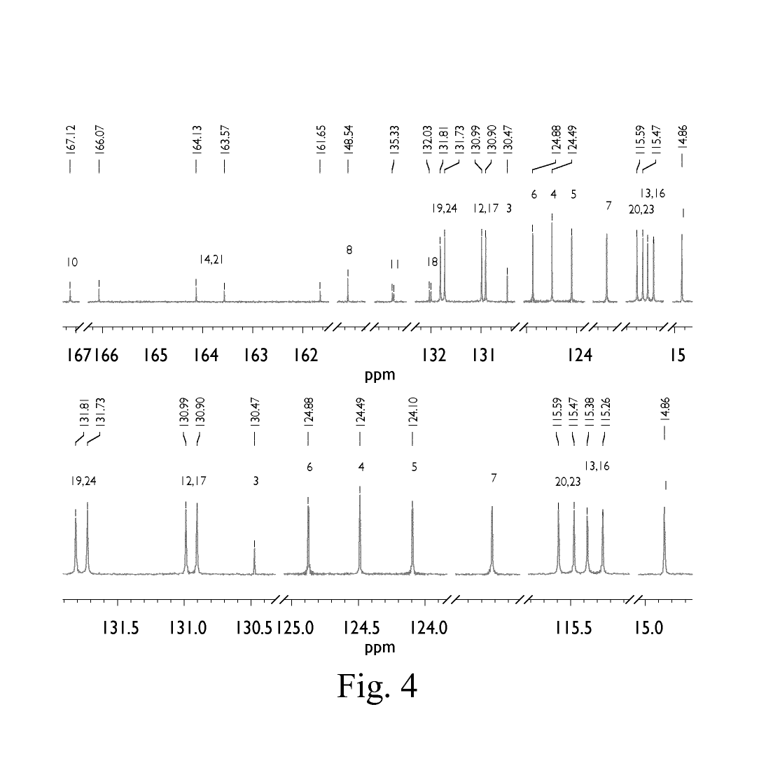

About 25 g and 24.43 g of bright yellow product was obtained for Approaches 1 and 2, respectively. The product was soluble in acetone and CHCl₃. Additionally, ¹FINMR and ¹³CNMR analysis on the product of Approach 1 confirmed that the product obtained was DFBPCH. FIG. 2 is a structural representation of DFBPCH with atom numbering. FIG. 3 is a ¹FINMR spectrum obtained from a solution of the product of Approach 1 in CDCl₃ showing peak assignments. FIG. 4 is the ¹³CNMR spectrum obtained from a solution of the product from Approach 1 in CDCl₃ with peak assignments, where the lower panel is an expansion of the upper panel showing ¹⁹F coupling. The product of Approach 1 had a melting temperature (“Tₘ”) of between 122° C. and 123° C.

Elemental analysis was conducted on a sample of the product from Approach 1. The results of the elemental analysis are shown in Table 2, below, which compares the measured amount of each element to the amount expected. Referring to Table 2, measured results were in good agreement with calculated values.

TABLE 2

| | C | H | N | F | S |
|---|---|---|---|---|---|
| Measured | 70.79 | 4.31 | 4.07 | 11.43 | 8.93 |
| (wt. %) | | | | | |
| Calculated | 70.78 | 4.45 | 4.13 | 11.20 | 9.45 |
| (wt. %) | | | | | |

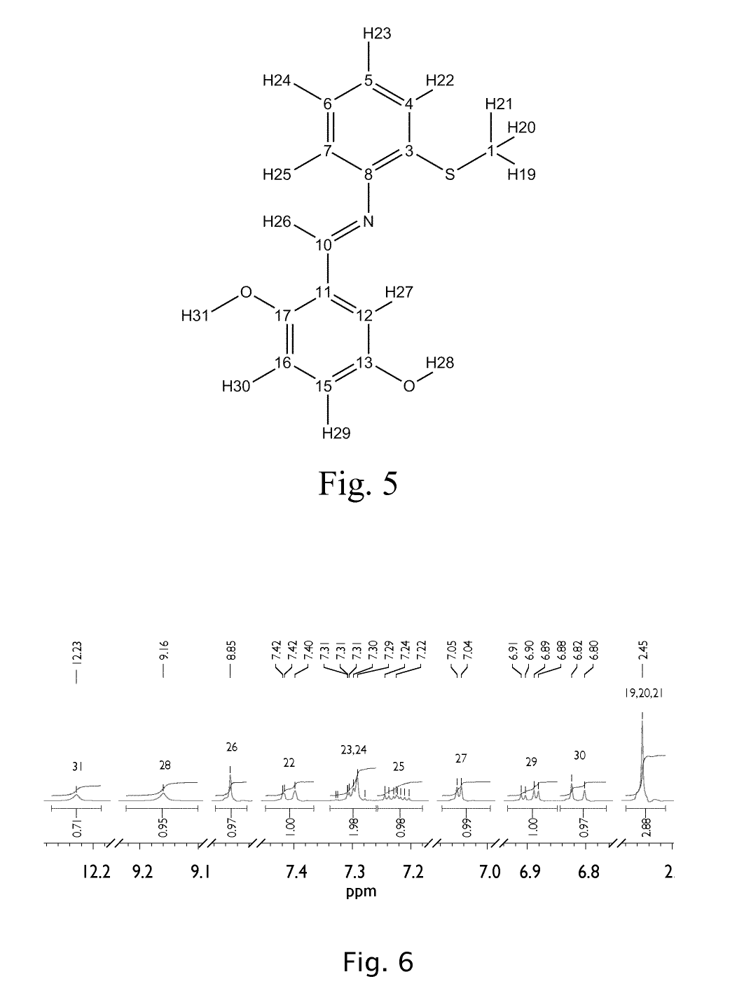

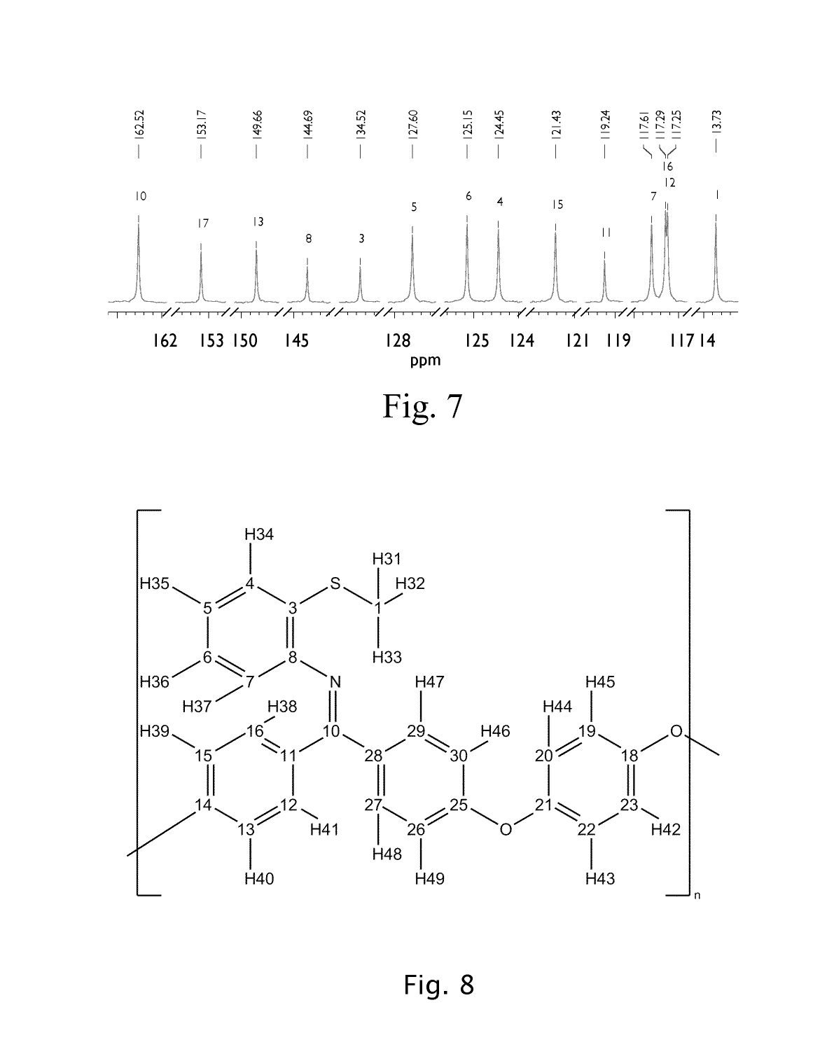

Synthesis of the HQCH monomer was demonstrated by adding about 4.96 g (0.036 mole) 2,5-dihydroxybenzaldehyde, 5.00 g (0.036 mole) 2-(methylthio)aniline and 40 mL n-butanol in 100 mL 3-neck round bottom flask fitted with a Dean Stark trap, mechanical stirrer and nitrogen inlet/outlet. The mixture was heated to reflux under a nitrogen atmosphere for about 1.5 hours, during this time distilling off the n-butanol and any water produced by the reaction. The remaining solids were dried in a vacuum oven overnight at 80° C. and, subsequently, recrystallized from ethanol as described above. About 6.62 g of product was recovered. ¹HNMR and ¹³CNMR analysis on the product confirmed that the product obtained was HQCH. FIG. 5 is a structural representation of HQCH with atom numbering. FIG. 6 is a ¹HNMR spectrum obtained from a solution of the product in DMSO-d₆ showing peak assignments. FIG. 7 is the ¹³CNMR spectrum obtained from a solution of the product in DMSO-d₆ with peak assignments.

### Example 2

### Synthesis and Characterization of Poly(Thiomethylimine Hydroquinone): Reaction of Functionalized Monomers

This example demonstrates the synthesis and characterization of poly(thiomethylimine hydroquinone), where the synthesis incorporates the reaction of a monomer functionalized with a chelating group. In particular, the synthesis is carried out by reacting a DFBPCH functionalized monomer according to the following scheme:

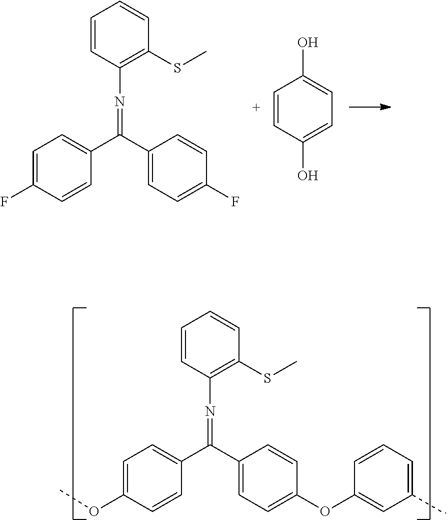

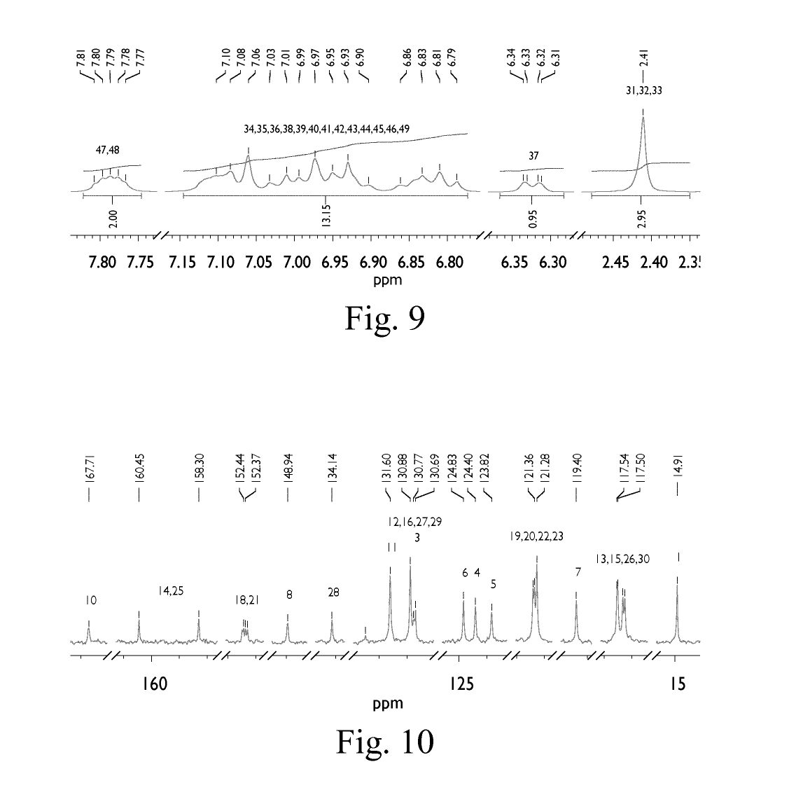

Synthesis of poly(thiomethylimine hydroquinone) was demonstrated using two different synthesis approaches, each approach using a different set of reaction conditions. For each synthesis, 10 g (0.0295 mol) of DFBPCH, 3.25 g (0.0295 mol) hydroquinone, 8.3 g (0.06 mol) potassium carbonate and 40 mililiters (“mL”) sulfolane were added to a 250 ml three neck round bottom flask fitted with a Dean-Stark trap with condenser, a mechanical stirrer and an nitrogen inlet/outlet. For the first approach, the mixture was stirred and refluxed at 215° C. under a nitrogen atmosphere for about 2.5 hr. For the second approach, the mixture was stirred and refluxed at 225° C. under a nitrogen atmosphere for about 8 hr. After refluxing, the mixtures were cooled to room temperature and diluted with 50 mL of N-methyl-2-pyrolidone (“NMP”). Each diluted mixture was transferred to a blender containing 400 mL methanol and 10 mL acetic acid and mixed on high speed for one minute. The contents were then poured on to a sintered glass funnel and vacuum filtered to obtain a yellow solid powder. The solids were transferred back to the blender and subsequently mixed on high speed with 200 mL 80 ° C. deionized (DI) water. The solids obtained upon another filtration were again transferred to the blender and washed with another 200 mL 80° C. portion of DI water. The solids were isolated by filtration and washed on the filter with 2×200 mL portions of deionized water and 2×300 mL portions of methanol. The washed product was dried in a vacuum oven for 2 hr. at 90° C. 10.93 g and 11.04 g of bright yellow product were obtained in the first and second approaches, respectively. In each approach, the product was characterized by ¹HNMR and ¹³CNMR as being poly(thiomethylimine hydroquinone). FIG. 8 is a structural representation of poly(thiomethylimine hydroquinone) with atom numbering. FIG. 9 is a ¹HNMR spectrum obtained from a solution of the product of Approach 2 in CDCl₃ showing peak assignments. FIG. 10 is the ¹³CNMR spectrum obtained from a solution of the product of Approach 2 in CDCl₃ with peak assignments. The product of Approach 2 had the following average molecular weights: Mₙ=12,839 g/mol, M_{w}=61,127 g/mol, M_{z}=120,698 g/mol and M_{z+1}=189,105 g/mol and a PDI of 4.76. The product of Approach 2 had a T_{g}=151° C. and T_{d5}=406° C. For both approaches, the product was soluble CHCl₃, dichloromethane and NMP.

The results also demonstrate that the desired molecular weight can be selected by controlling the temperature. In particular, the weight average molecular weight of the of poly(2-methylthioaniline hydroquinone) was 37,188 g/mol in the first approach (215° C. for 2.5 hr.) and 61,127 g/mol in the second approach (225° C. for 8 hr.)

### Example 3

### Synthesis of Poly(Thiomethylimine Hydroquinone)—PEEK Copolymer

This example demonstrates the synthesis of a poly(thiomethylimine hydroquinone)—PEEK Copolymer according to the following scheme:

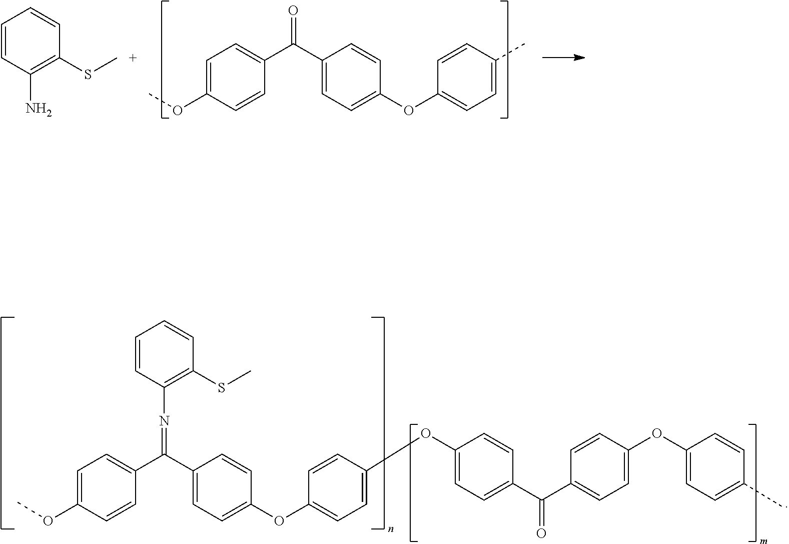

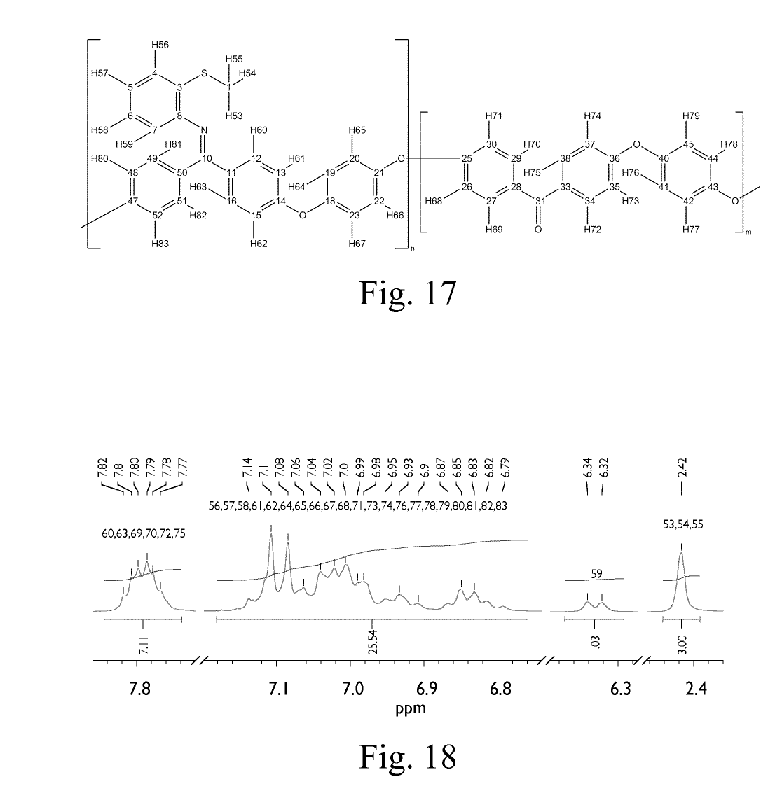

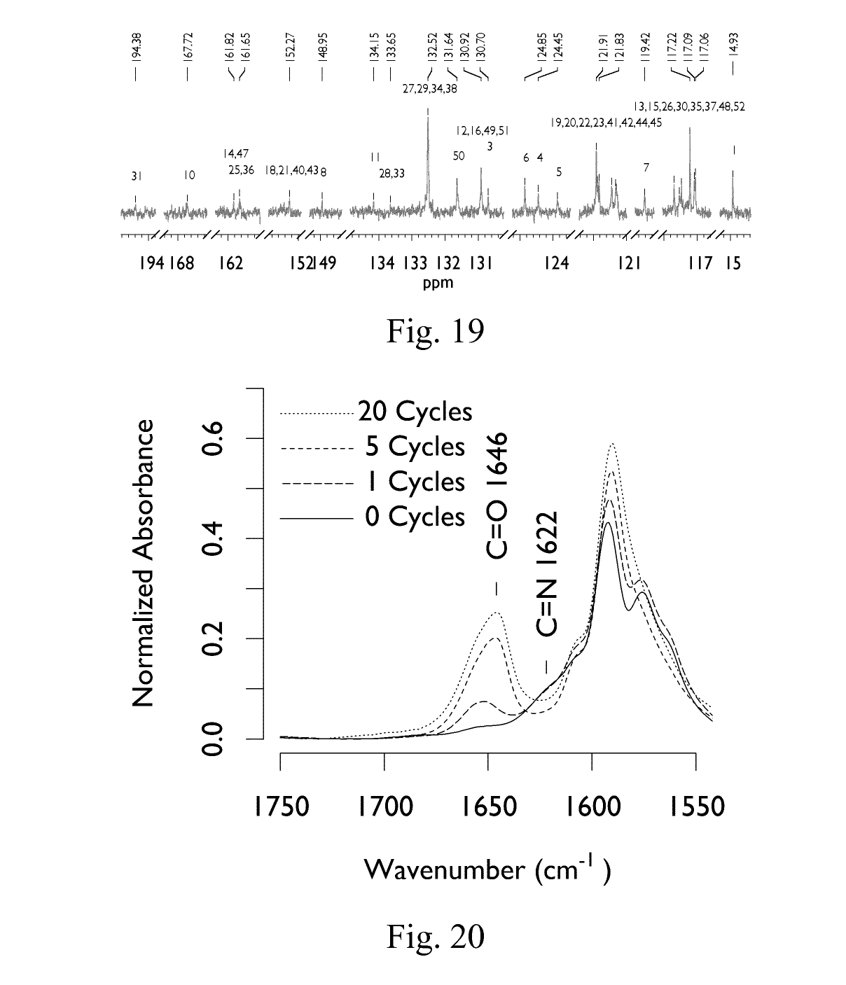

To demonstrate synthesis, a mixture of PEEK (Mn=48,502, Mw=97,936) (6.90 g), 2-(methylthio)aniline (15.0 g, b.p. 234° C.) and diphenyl sulfone (“DPS”) (55.95 g) was added to a 250 mL three-round bottom flask fitted with a condenser, Dean-Stark trap, overhead stirrer, and nitrogen inlet. The PEEK used is commercially available under the trade name KetaSpire® PEEK KT-820FP from Solvay Specialty Polymers USA, L.L.C. (Alpharetta, Ga., USA). The PEEK/DPS mixture was continuously stirred and heated at 320° C. until the PEEK fully dissolved in the molten DPS and, subsequently, then the temperature was reduced to 295° C. and the 2-(methylthio)aniline was added. The mixture was continuously heated at 295° C. and stirred for 8 hours, after which the reaction was stopped and left at room temperature overnight. After addition of 100 mL acetone, the product was isolated by filtration and washed with 2×200 mL portions of acetone. Residual DPS was removed by refluxing the filter cake in 200 mL of ethyl acetate for 1 hour, followed by vacuum filtration to collect the solid. The reflux extraction was repeated twice in ethyl acetate and twice in acetone. The yellow product was dried in a vacuum oven at 90° C. for 2 hours. The isolated yield was 9.26 g. The product was confirmed by ¹HNMR and ¹³CNMR to be a poly(thiomethylimine hydroquinone)—PEEK copolymer. FIG. 17 is a structural representation of the poly(thiomethylimine hydroquinone)—PEEK copolymer with atom numbering. FIG. 18 is a ¹HNMR spectrum obtained from a solution of the product in CDCl₃ showing peak assignments. FIG. 19 is the ¹³CNMR spectrum obtained from a solution of the product in CDCl₃ with peak assignments. The product was also characterized using X-ray fluorescence (“XRF”) spectroscopy using a Rigaku ZSX Primus II from Rigaku Americas Corp. (The Woodlands, Tex., USA). Based upon the XRF measurements, the polymer had a sulfur concentration of about 3.4 wt. %. Based on the ⁱHNMR peak integrations and the wt. % S obtained from XRF, the degree of substitution was determined to be approximately 38% (i.e. the mole fractions n and m have the following values: n=0.38 and m=0.62 in the above scheme). The copolymer had the following average molecular weights: Mₙ=27.1 kDa, M_{w}=63.2 kDa, M_{Z}=152.9 kDa and M_{z+1}=308.8 kDa and a PDI of 2.33. The copolymer had a T_{g} of 153° C. and a T_{d5} of 410° C. The product was soluble in CHCl₃ and CH₂Cl₂.

### Example 4

### Synthesis of Poly(Thiomethylimine Biphenol)

This example demonstrates the synthesis and characterization of a poly(thiomethylimine biphenol) polymer, where the synthesis is carried-out according to the following scheme:

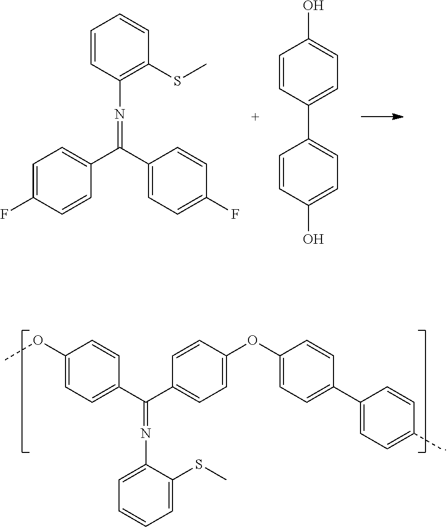

Synthesis poly(thiomethylimine biphenol) was demonstrated by using 3 different synthesis approaches, each approach using a different set of reaction conditions. In each approach, N-bis(4-fluorophenylmethylidene)-2-methylsulfonylaniline), biphenol, potassium carbonate and 40 mL sulfolane were added to a 250 ml three neck round bottom flask fitted with a Dean-Stark trap with condenser, a mechanical stirrer and an nitrogen inlet/outlet. Each mixture was stirred and refluxed under a nitrogen atmosphere. After refluxing, each mixture was cooled to room temperature and diluted with 50 mL NMP. The diluted mixture was transferred to a Waring blender containing 400 mL methanol and 10 ml, acetic acid. The mixture was then filtered and the bright yellow solid was twice washed with deionized water at 80° C. in the blender and subsequently washed on a filter with 2×200 mL portions of deionized water and 2×300 mL portions of methanol. The washed product was dried in a vacuum oven for 2 hr. at 90° C. The reaction conditions for each approach are displayed in Table 3, below.

TABLE 3

| | | | | Reflux | |
|---|---|---|---|---|---|
| | Amount of Starting Materials | | | Parameters | |
| | (g/mol) | | | Time/Temp | |
| | N-bis(4-fluorophenylmethylidene)- | | | (hr./° C.) | |
| | 2-methylsulfonylaniline) | Biphenol | K₂CO₃ | Step 1 | Step 2 |
| Approach 1 | 5.00/0.01473 | 2.74/0.01473 | 3.04/0.022 | 4/170 | 2/190 |
| Approach 2 | 10.00/0.2946 | 5.49/0.2946 | 8.3/0.60 | 2.5/215 | None |
| Approach 3 | 10.00/0.2946 | 5.49/0.2946 | 8.3/0.60 | 8/225 | None |

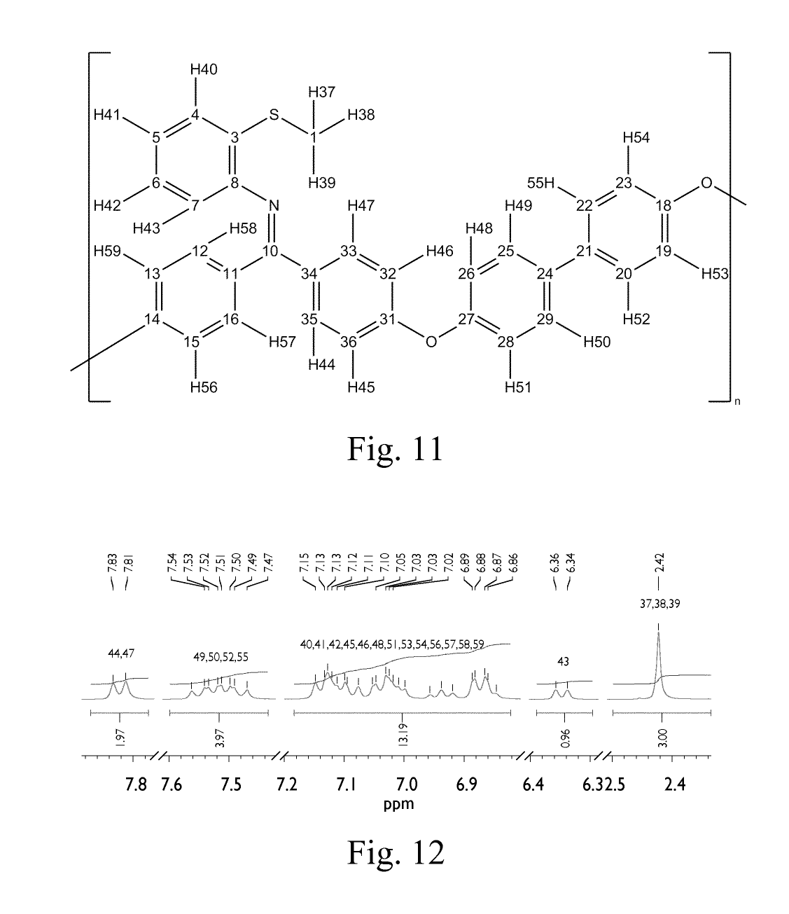

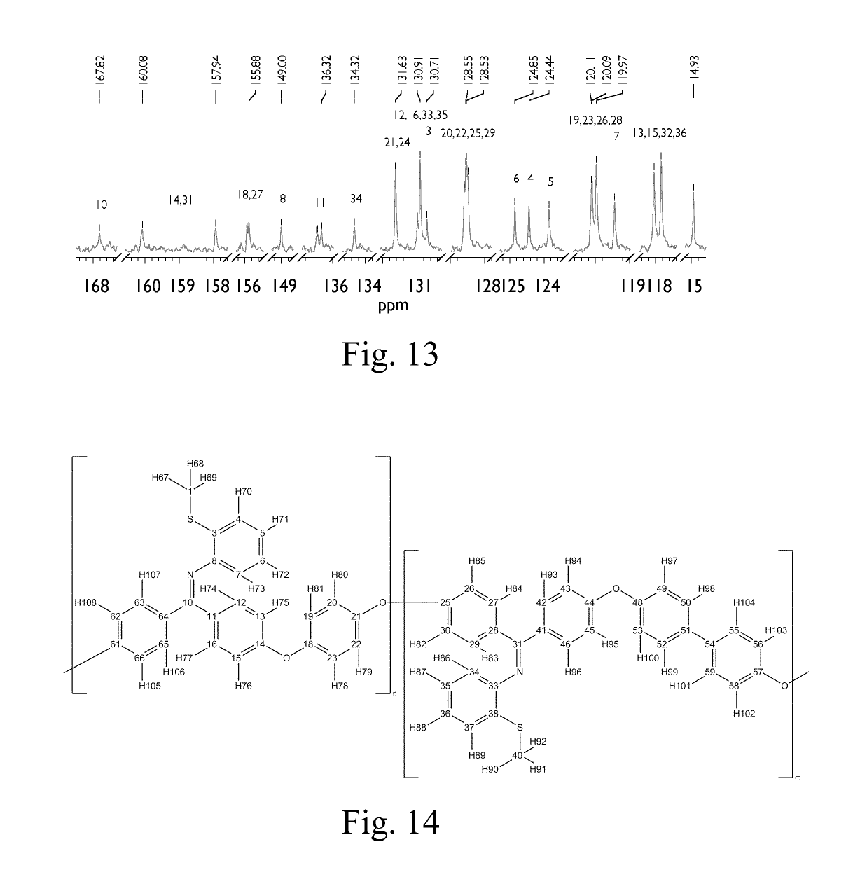

Referring to Table 3, in Approach 1, the mixture was initially refluxed for 4 hr. at 170° C. and, subsequently for 2 hr. at 190° C. Approaches 2 and 3 had only one set of reflux parameters. For each approach, the product obtained was characterized by ¹HNMR and ¹³CNMR as being poly(thiomethylimine biphenol). FIG. 11 is a structural representation of poly(thiomethylimine biphenol) with atom numbering. FIG. 12 is a representative ¹HNMR spectrum of the product of Approach 3 in CDCl₃ showing peak assignments. FIG. 13 is a representative ¹³CNMR spectrum of a solution of the product of Approach 3 in CDCl₃ with peak assignments.

The results of the characterization of the poly(thiomethylimine biphenol) polymers produced from the different synthetic approaches are displayed in Table 4, below:

TABLE 4

| Ap- | Molecular Weight | | | | | | | | ηᵢₙₕ |
|---|---|---|---|---|---|---|---|---|---|
| proach | (kDa) | | | | | Tg | Td₅ | Char | (dL/ |
| No. | Mₙ | M_{w} | M_{z} | M_{z+1} | PDI | (° C.) | (° C.) | (%) | g) |
| 1 | 8.1 | 17.1 | 40.7 | 150 | 2.11 | 157 | 389 | 41.17 | 0.22 |
| 2 | 21.2 | 70.0 | 126 | 188 | 3.31 | 220 | 392 | 47.15 | 0.57 |
| 3 | 13.7 | 258 | 549 | 725 | 18.8 | 179 | 415 | | |

### Example 5

### Synthesis of Poly(Thiomethylimine Hydroquinone)—Poly(Thiomethylimine Biphenol) Copolymer

This example demonstrates the synthesis and characterization of a poly(thiomethylimine hydroquinone)-poly(thiomethylimine biphenol) copolymer according to the following scheme:

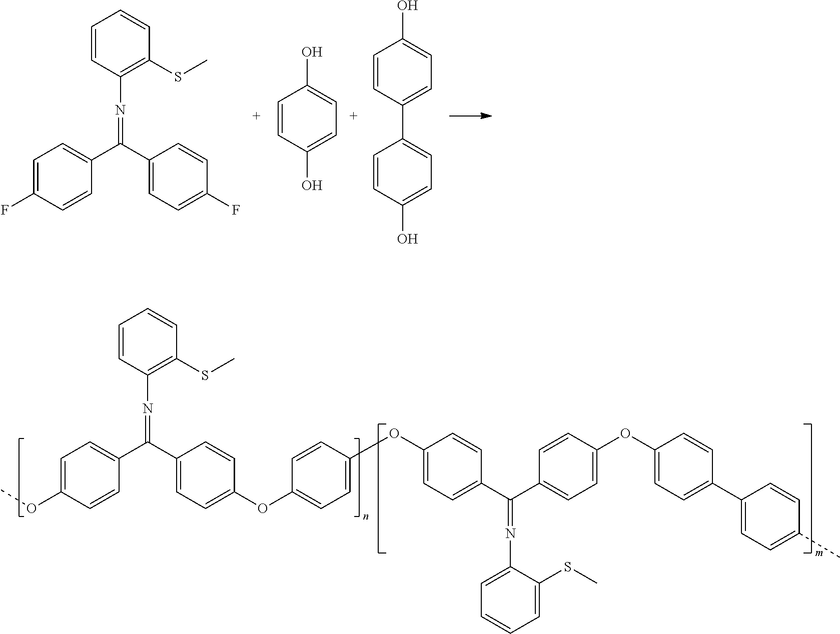

Synthesis of the copolymer was demonstrated by adding 10 g (0.0295 mol) of N-bis(4-fluorophenylmethylidene)-2-methylsulfonylaniline), 1.62 g (0.0148 mol) hydroquinone, 2.76 g (0.148 mol) biphenol, 8.3 g (0.06 mol) potassium carbonate and 40 mL sulfolane were added to a 250 ml three neck round bottom flask fitted with a Dean-Stark trap with condenser, a mechanical stirrer and an nitrogen inlet/outlet. The mixture was stirred and heated at 225° C. under a nitrogen atmosphere for about 8 hr. After heating, the mixture was cooled to room temperature and diluted with 50 mL NMP. The diluted mixture was transferred to a running blender containing 400 mL methanol and 10 mL acetic. The solid product was then collected by filtration, returned to the blender, and washed with deionized water at 80° C. The solid product was again collected by filtration, washed and collected by filtration. The filter cake was washed with 2×200 mL portions of deionized water and 2×300 mL portions of methanol. The washed product was dried in a vacuum oven for 2 hr. at 90° C. 11.92 g of product was obtained.

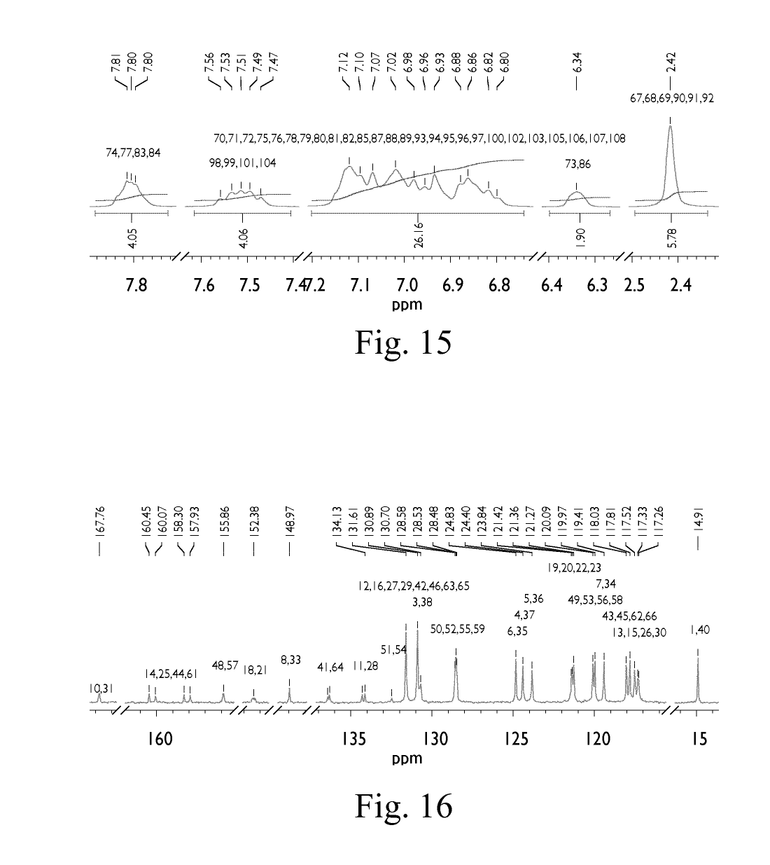

The product was characterized by ¹HNMR and ¹³CNMR as being a poly(thiomethylimine hydroquinone)-poly(thiomethylimine biphenol) copolymer, where the mole fractions n and m are both equal to 0.5. FIG. 14 is a structural representation of the poly(thiomethylimine hydroquinone)-poly(thiomethylimine biphenol) copolymer with atom numbering. FIG. 15 is a ¹HNMR spectrum obtained from a solution of the product in CDCl₃ showing peak assignments. FIG. 16 is the ¹³CNMR spectrum obtained from a solution of the product in CDCl₃ with peak assignments.

The product had the following average molecular weights: Mₙ=20,092 g/mol, M_{w}=277,997 g/mol, M_{z}=571,666 g/mol and M_{z+1}=757,070 g/mol and a PDI of 13.84. The product a T_{g}=171° C. and T_{d5}=417° C. The product was soluble CHCl₃, dichloromethane and NMP.

### Example 6

### Performance of PAE Adhesive Compositions: Lap Shear Strength

This Example demonstrates the lap shear performance of PAE adhesive compositions.

To demonstrate lap shear performance, 11 lap shear samples were formed as described above. In particular, each lap shear sample contained a PEEK polymer overmolded by injection molding over a metal substrate using an injection mold with a right-rectangular cavity having dimensions of 5×0.5×0.175 inches. A metal insert measuring 2.5×0.5×0.175 inches and having a 0.5×0.5×0.875 inch lap machined at one end was placed into the mold before injection molding.

Prior to overmolding the PEEK polymer, for some samples, a PAE adhesive composition and/or adhesion promoter was applied to the substrate using dip coating prior to overmolding the PEEK polymer. Adhesion promoters were applied directly to the metal substrate. The adhesion promoter used in the samples were zirconium (IV) tetra-n-butoxide in n-butanol (“ZR”), which is commercially available under the trade name Tyzor® NBZ from Dorf Ketal™ Chemicals LLC (Houston, Tex., USA). PAE adhesive compositions were applied after application of the adhesion promoter (if present) and prior to overmolding the PEEK polymer. The PAE adhesive composition contained poly(thiomethylimine hydroquinone) (“PTH”), poly(thiomethylimine biphenol) (“PTB”) or the copolymer thereof (“PTH/PTB”). The copolymer consisted of about 50 mol % thiomethylimine hydroquinone recurring units and about 50 mol % thiomethylimine biphenol recurring units. The PAE chelating agents were synthesized as described in the Examples above. For some samples incorporating aluminum substrates, prior to deposition of any coating, the substrates were pretreated using phosphoric acid anodization according to the ASTM D3933-2010 standard.

Lap shear tests were run in accordance with ASTM D1002. The single-lap specimens were tested using an Instron 5569 electromechanical test frame configured with a 50 KN load cell and 100 kN capacity manual grips with 55×25 nun serrated metallic faces at room temperature under displacement control (0.05 in/min). The average shear strength was calculated as the average load of each test between 0.1 inch and 2.1 inches of extension, divided by the measured bond area. The failure modes were determined by visual inspection. In some cases, a subset of the test samples failed by fracture through the polymer, leaving the metal-to-polymer adhesive bond intact. These were treated as right-censored measurements when computing the average. Table 5 displays the lap shear sample parameters and the results of lap shear testing. In Table 5, the “*” indicates that the failure of one or more individual test samples was due to the PEEK polymer and not failure at the junction.

TABLE 5

| | | | | | Lap Shear |
|---|---|---|---|---|---|
| | | Surface | Adhesion | PAE Adhesive | Strength |
| | Substrate | Treatement | Promoter | Composition | (MPa) |
| 1 | Stainless | None | None | None | 14.7 |
| | Steel | | | | |
| 2 | Aluminum | Anodization | None | PTB | 11.1* |
| 3 | Aluminum | Anodization | None | PTH | 11.9* |
| 4 | Stainless | None | ZR | PTH/PTB | 9.7 |
| | Steel | | | | |
| 5 | Aluminum | None | ZR | PTH/PTB | 9.5 |
| 6 | Stainless | None | ZR | PTB | 9.2 |
| | Steel | | | | |
| 7 | Aluminum | None | ZR | PTB | 8.2 |
| 8 | Aluminum | None | ZR | PTH | 8.0 |
| 9 | Aluminum | Anodization | None | None | 5.0 |
| 10 | Aluminum | None | None | None | 0.0 |
| 11 | Stainless | None | None | None | 0.0 |
| | Steel | | | | |

The results demonstrate that, for the samples tested, samples incorporating a PAE adhesive composition had significantly improved lap shear strength relative to corresponding samples free of a PAE adhesive composition. Referring to Table 5, samples 2 (PTB adhesive composition) and 3 (PTH adhesive composition) had significantly larger lap shear strengths (more than 11.1 MPa and 11.9 MPa, respectively) compared with samples 10 (no adhesive composition) and 11 (no adhesive composition). The lap shear values of 0.0 for samples 10 and 11 indicate that the overmolded PEEK spontaneously delaminated from the substrate on cooling after injection molding. The results also demonstrate that samples having PTH/PTB adhesive compositions had improved lap shear performance relative to corresponding samples having either PTH or PTB adhesive compositions. For example, sample 5 (PTH/PTB adhesive composition) had a lap shear strength of about 9.5 MPa while samples 7 (PTB adhesive composition) and 8 (PTH adhesive composition) had lap shear strengths of about 8.2 MPa and about 8.0 MPa, respectively. Similarly, sample 4 (PTH/PTB adhesive composition) had a lap shear strength of about 9.7 MPa while sample 6 (PTB adhesive composition) had a lap shear strength of about 9.2 MPa.

Table 5 also demonstrates the effects of adhesion promoters on the lap shear strength of the samples. Comparison of sample 11 with that of sample 7, demonstrates that an adhesion promoter can be extremely effective in further increasing the adhesive strength of the PAE adhesive compositions. In particular, sample 11 (no adhesion promoter) had a lap shear strength of about 0.6 MPa while sample 7 (zirconium (IV) tetra-n-butoxide in n-butanol adhesion promoter) had a lap shear strength of about 9.2 MPa. Table 5 also demonstrates that for the samples tested, surface anodization can be more effective in increasing lap shear strengths, relative to use of an adhesion promoter alone. For example, samples 2 and 3 (surface anodization) had lap shear strengths of more than 11.1 MPa and 11.9 MPa, respectively, while sample 8 and 9 (zirconium (IV) tetra-n-butoxide in n-butanol adhesion promoter) has lap shear strengths of 8.2 MPa and 8.0 MPa respectively.

### Example 7

### Performance of PAE Adhesive Compositions: Peel Strength

This Example demonstrates the peel performance of PAE adhesive compositions.

To demonstrate peel performance, peel strength samples were fabricated. In particular, each peel strength sample contained a PEEK polymer overmolded in an injection mold with a right rectangular cavity having dimensions 2×3×0.125 inches. A 2×3 inch piece of aluminum 1100 foil having one end masked with a 0.5×2 inch piece of Kapton tape was placed into the mold before injection molding in order to leave a non-adhered tab that could be gripped.

Prior to overmolding the PEEK polymer, for some samples, a PAE adhesive compositions and/or one or more adhesion promoters were coated onto the aluminum substrates. The adhesion promoter was coated directly onto the aluminum substrate using dip coating, as described above, or as specified by the manufacturer. For samples in which more than one adhesion promoter was used, the adhesion promoters were formed into a mixture and the aluminum substrate was dip coated into the mixture. The adhesion promoters used were ZR; titanium (IV) di-iso-propoxide bis (actylacetonate) (“TI”), commercially available under the trade name Tyzor AA-65 from Dorf Ketal Chemicals LLC (Houston, Tex., USA); 2,2,4,4-tetramethyl-1,3-cyclobutanediol polymer with DFBP (“CDBO”), synthesized as described in WO 2014/096269 to Taylor et al., filed Dec. 12, 2013 and incorporated herein by reference; (3-isocyanatopropyl)triethoxysilane (“NCO”), commercially available from Gelest, Inc. (Morrisville, Pa., USA); (3-glycidoxypropyl)triethoxysilane (“epoxysilane”), commercially available from Gelest Inc. (Morrisville, Pa., USA); 3-aminobenzoic acid+hexamethoxymelamine (“3ABA”), respectively commercially available from Thermo Fisher Scientific (Waltham, Mass., USA) and under the trade name Cymel® 303 from Allnex (Brussels, Belgium); 2-dihydroxybenzoic acid polymer with DFBP (“PEEK-COOH”), synthesized by the reaction of 4,4′-difluorobenzophenone with 2,5-dihydroxybenzoic acid; polyisosorbideketone (“PIK”), synthesized as described in US 2014/0186624 to Sriram et al., filed Aug. 9, 2012 and incorporated by reference herein; polysulfoneisosorbide (“PSI”), synthesized as described in WO 2014/072473 to Taylor et al., filed Aug. 11, 2013 and incorporated by reference herein; and reactive poly(aryl ether sulfone) (“PAES”), commercially available under the trade names Virantage® PESU VW-30500RP (“PAES 1”) and VW-10200P (“PAES 2”), both from Solvay Specialty Polymers USA, L.L.C (Alpharetta, Ga., USA).

The PAE adhesive compositions were applied after application of the adhesion promoter (if present) and prior to overmolding the PEEK polymer. The PAE adhesive compositions contained PTH, PTB, the copolymer PTH/PTB, a PTH-PEEK copolymer or a PEEK/PTH polymer blend (wt % PEEK and wt % PTH?). The PTH, PTB, PTH/PTB and PTH-PEEK polymers were synthesized as described above. The PEEK polymer used for the PEEK/PTH blend was KetaSpire® PEEK KT-820 GF 30, commercially available from Solvay Specialty Polymers USA, LLC (Alpharetta, Ga., 30328). For some samples, the PAE adhesive composition was dip coated, powder coated, or blade coated onto the aluminum substrates as described above. For some samples, prior to deposition of any coating, the aluminum substrates were pre-treated using phosphoric acid anodization according to the ASTM D3933-2010 standard.

Peel strengths tests were run in accordance with ASTM D3330. To determine peel strength, an Instron 5581 electromechanical test frame was configured with a 100 N load cell and a set 90-degree peel fixture consisting of a bearing mounted sled that is linked to the crosshead of the machine by a cable and pulley system. A 0.125 inch wide strip of foil was cut and removed from each edge to allow the sample to be clamped into the peel test fixture. Samples were gripped by the 0.5 inch foil strip that had previously been masked with Kapton tape and peeled at a rate of 2 in/min. For some samples, peel strength testing was performed after annealing the sample at about 200° C. for about 2 hours, subsequent to PEEK overmolding.

Table 6 displays the parameters of each sample. For samples having pre-annealing and post-annealing peel strengths results, a person of ordinary skill in the art will recognize that although a single sample number is listed, the corresponding sample was prepared in duplicate, where one of the duplicate samples is annealed and subsequently subjected to peel strength testing and where the other duplicate sample is not-annealed and is subjected to peel strength testing.

TABLE 6

| | | | | | Pre- | Post |
|---|---|---|---|---|---|---|
| | | | | PAE | Annealing | Annealing |
| | | | | Adhesive | Peel | Peel |
| | Surface | Adhesion | PAE Adhesive | Application | Strength | Strength |
| | Treatement | Promoter | Composition | Method | (lb · f/in.) | (lb · f/in.) |
| 1 | None | PAES2/ | None | | 0.11 | |
| | | epoxysilane/ | | | | |
| | | 3ABA | | | | |
| 2 | None | CBDO | None | | 0.43 | 0.68 |
| 3 | None | PAES1/ | None | | 0.59 | |
| | | epoxysilane/ | | | | |
| | | 3ABA | | | | |
| 4 | None | PAES1/NCO/ | None | | 0.38 | 0.67 |
| | | 3ABA | | | | |
| 5 | None | None | None | | | 0.00 |
| 6 | Anodization | None | PTH | Dip | | 11.69 |
| 8 | None | None | PTB | Dip | 2.05 | 1.53 |
| 9 | None | None | PTH | Dip | | 5.44 |
| 10 | None | None | PTH | PC | | 2.74 |
| 11 | None | None | PEEK/PEECH | PC | | 7.35 |
| | | | blend | | | |
| 12 | None | PEEK-COOH | None | | 0.48 | 0.55 |
| 13 | None | None | PEEK-PEECH | PC | | 2.66 |
| | | | copolymer | | | |
| 14 | None | None | PEEK-PEECH | Blade | | 5.65 |
| | | | copolymer | | | |
| 15 | None | PIK | None | | 0.49 | |
| 16 | None | PSI | None | | | 0.71 |
| 180 | None | Ti | None | | 0.38 | |
| 22 | None | Zr | None | | 0.27 | 0.45 |
| 23 | None | Zr | None | | 0.71 | 0.85 |
| 24 | None | Zr | PTB | Blade | | 2.44 |
| 25 | None | Zr | PTH/PTB | Blade | | 3.55 |
| 26 | None | Zr | PTH | Blade | | 2.78 |
| 27 | None | Zr | None | | 0.13 | 0.39 |

The peel strength results demonstrate that for the samples tested, PAE adhesive compositions significantly improved the peel strength relative to samples that were free of PAE adhesive compositions. For example, comparison of samples 8 (PTB, no adhesion promoter), 9 (PTH, no adhesion promoter) and 10 (PTH, no adhesion promoter) with samples free of an adhesive composition demonstrate significantly increased peel strengths, notwithstanding the presence of an adhesion promoter. In particular, comparision of samples 8, 9 and 10 with 2 (CBDO), 4 (PAES1/NCO/3ABA), 5 (no adhesion promoter), 16 (PSI), 23 (Zr) and 17 (Zr), demonstrates that samples having a PTB or PTH PAE adhesive composition had increased post-annealing peel strength relative to samples free of PTB or PTH. Similar results were obtained with respect to pre-annealing peel strength as demonstrated by comparison of sample 8 (PTB) with samples 1 to 4, 12, 15, 18, 22, 23 and 27. Furthermore, comparison of sample 9 (no anodization) with sample 6 (anodization) demonstrate that anodization resulted in over 100% increased peel strength.

Additionally, Table 6 demonstrates that for the samples tested, ZR alone did not providing desirable peel strengths, however, it generally increased the effectiveness of other adhesion promoters as well as the PAE adhesive compositions.

### Example 7

### Conversion of PAE Chelating Agent to Corresponding PAEK

This Example demonstrates the conversion of PAE chelating agents to corresponding PAEK polymers. In particular, this Example demonstrates the hydrolytic conversion of poly(thiomethylimine biphenol) to a PEEK polymer according to the following scheme.

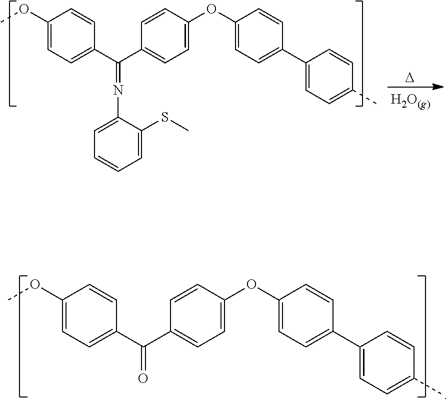

To demonstrate hydrolytic conversion, a film was formed poly(thiomethylimine bisphenol) synthesized as described above. The film was formed by casting a solution containing poly(thiomethylimine bisphenol) and NMP on a glass substrate. The cast film was then peeled and placed on a substrate. The film had an average thickness of about 1.5 mil. (1 mil=0.001 in.) The film was then subjected to 20 autoclave cycles. Each autoclave cycle consisted of heating the film in an atmosphere of steam to about 134° C. for about 18 min. and, subsequently, cooling the film to room temperature. Prior to autoclaving, and after the 1^{st}, 5^{th} and 20^{th} cycles, FTIR analysis was performed on the film using a Perkin Elmer Spectrum 200 Explorer FTIR spectrometer.

The FTIR spectra demonstrate that the imine bond of the poly(thiomethylimine bisphenol) was hydrolytically cleaved to form the corresponding poly(ether ether ketone). FIG. 19 is a graph showing the FTIR spectra taken of the film prior to autoclaving and after the 1^{st}, 5^{th} and 20^{th} autoclave cycles. FIG. 19 demonstrates that increased autoclaving reduced the imine peak and increased the carbonyl peak, indicating hydrolytic conversion of the imine bond to a carbonyl bond.

Should the disclosure of any patents, patent applications, and publications which are incorporated herein by reference conflict with the description of the present application to the extent that it may render a term unclear, the present description shall take precedence.”

1-16: (canceled)

17. A poly(aryl ether) (PAE) polymer comprising:
a recurring unit (R_{PAE}) including a Ar—C(=M)—Ar′ group, where Ar and Ar′, the same or different, comprise an aromatic group and M is a chelating group represented by the formula
═N—R₃ [symbol] ER₁R₂,
wherein:
R₁ and R₂ are each an optional group with the provisio that if present, are independently selected from the group consisting of a hydrogen, a halogen, an alkyl, an alkenyl, an alkynyl, an aryl, an ether, a thioether, a carboxylic acid, an ester, an amide, an imide, an alkali or alkaline earth metal sulfonate, an alkyl sulfonate, an alkali or alkaline earth metal phosphonate, an alkyl phosphonate, an amine and a quaternary ammonium;
R₃ is C₂ to C₅₀ linear, branched or cyclic hydrocarbon;
N and E and separated by at least 2 carbon atoms; and
E has at least one pair of lone electrons and is selected from group VA and VIA elements.

18. The poly(aryl ether) (PAE) polymer of claim 17, wherein recurring unit (R_{PAE}) is represented by a formula selected from the following group of formulae consisting of: 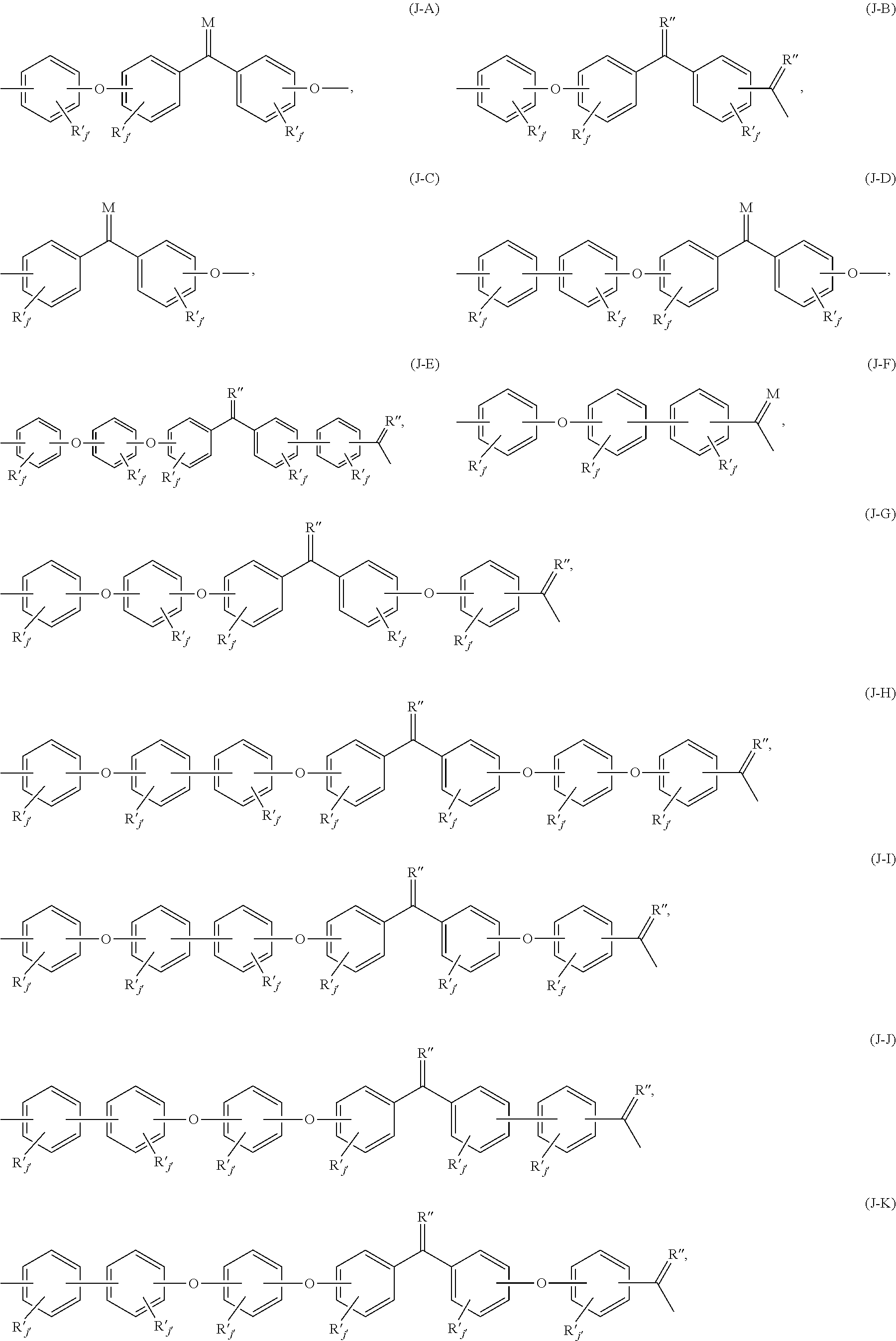 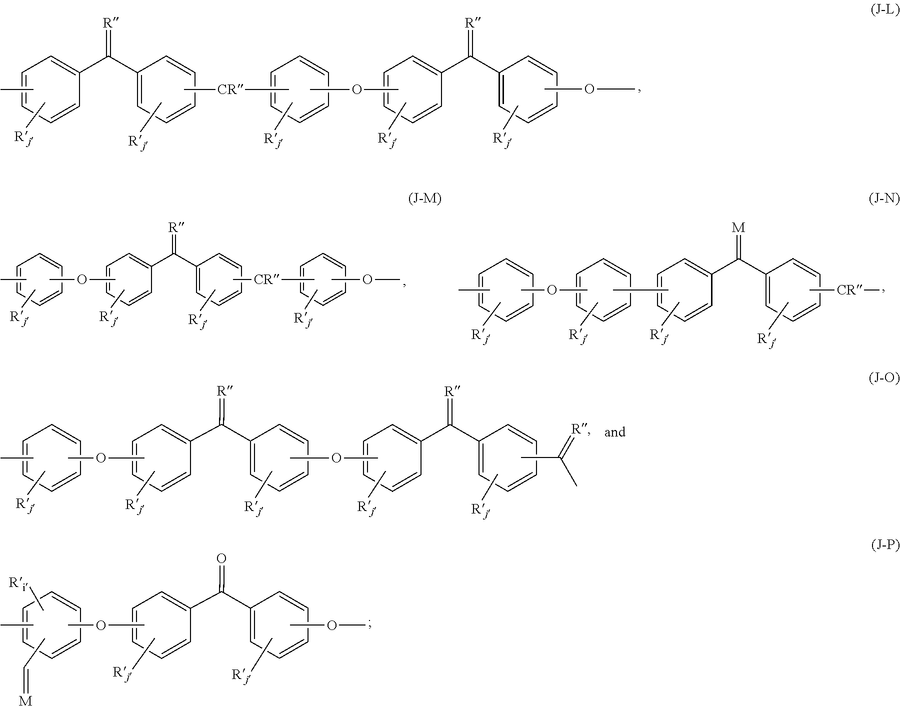
wherein:
each R′_{i′} and R′_{j′} is independently selected from the group consisting of a halogen, an alkyl, an alkenyl, an alkynyl, an aryl, an ether, a thioether, a carboxylic acid, an ester, an amide, an imide, an alkali or alkaline earth metal sulfonate, an alkyl sulfonate, an alkali or alkaline earth metal phosphonate, an alkyl phosphonate, an amine and a quaternary ammonium;
each R″ is independently selected from an O atom and M group with the provisio that at least one R″ is an M;
each j′ is an independently selected integer from 0 to 4; and
i′ is an integer from 1 to 3.

19. The poly(aryl ether) (PAE) polymer of claim 18, wherein the recurring unit (R_{PAE}) is represented by a formula selected from the following group of formulae consisting of:

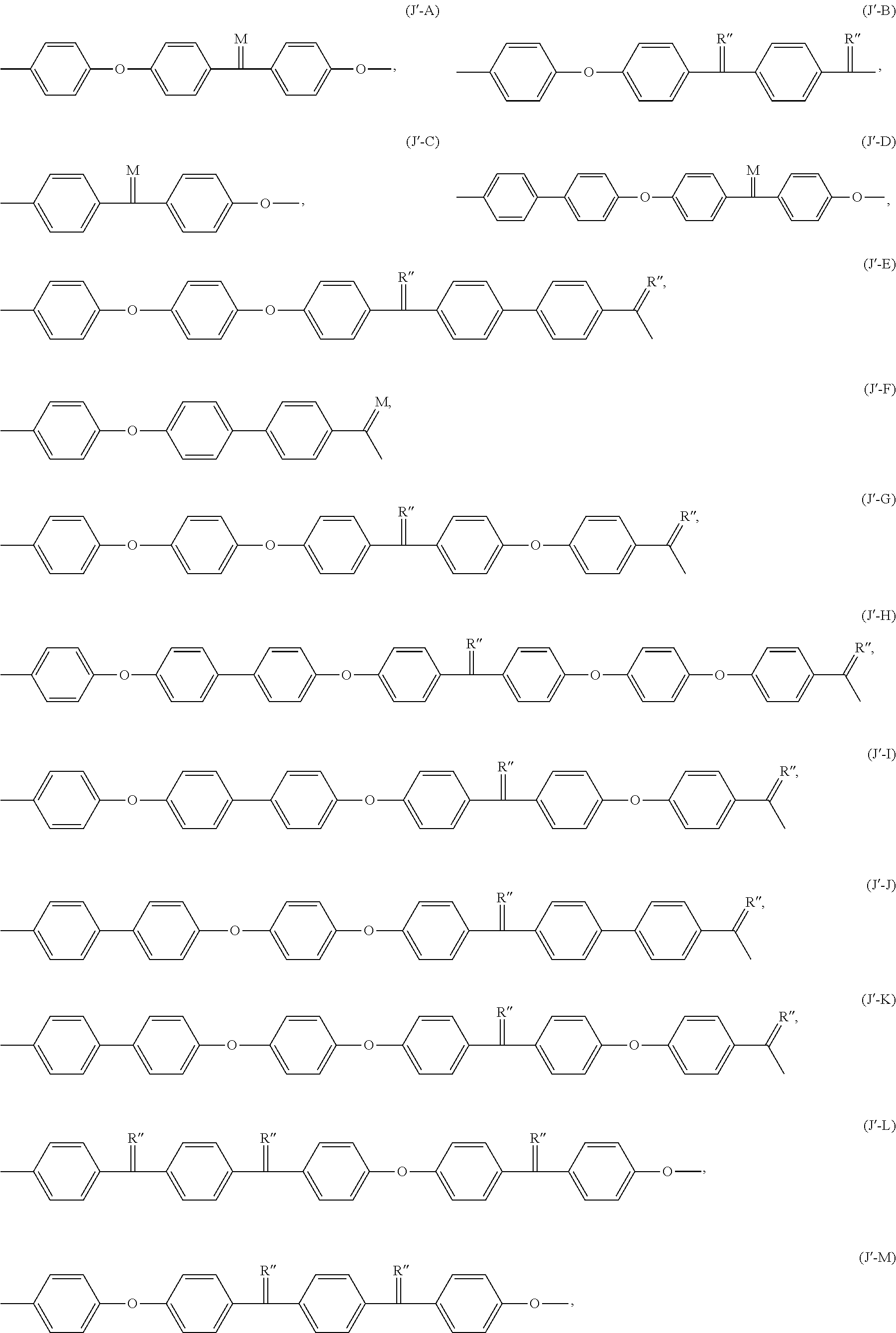

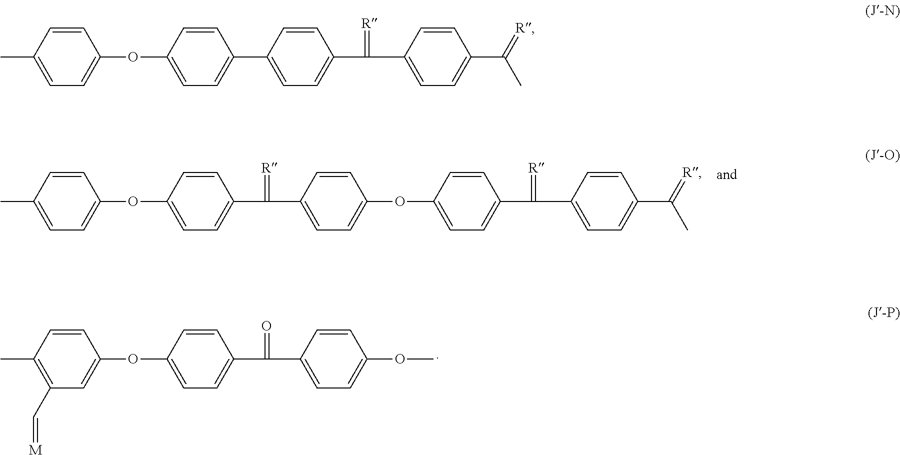

20. The poly(aryl ether) (PAE) polymer of claim 17, wherein the chelating group M is represented by a formula selected from the following group of formulae consisting of: 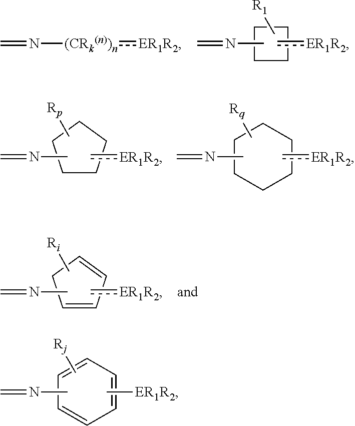
wherein:
each Rᵢ, Rᵢ, Rₖ, Rₗ, R_{q}, R_{q} is independently selected from the group consisting of a hydrogen, a halogen, an alkyl, an alkenyl, an alkynyl, an aryl, an ether, a thioether, a carboxylic acid, an ester, an amide, an imide, an alkali or alkaline earth metal sulfonate, an alkyl sulfonate, an alkali or alkaline earth metal phosphonate, an alkyl phosphonate, an amine and a quaternary ammonium;
i and j are independently selected integers from 0 to 4;
each k is an independently selected integer from 0 to 2;
l is an integer from 0 to 6;
p is an integer from 0 to 8;
q is an integer from 0 to 10; and
n is an integer from 2 to 4.

21. The poly(aryl ether) (PAE) polymer of claim 20, wherein the chelating group M is represented by the formula:

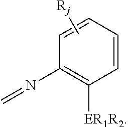

22. The poly(aryl ether) (PAE) polymer of claim 20, wherein [symbol] ER₁R₂ is represented by a formula selected from the group of formulae consisting of ═O, ═S, ═NR₁,═PR₁R₂, —NR₁R₂, —OR₁, and —SR₁.

23. The poly(aryl ether) (PAE) polymer of claim 20, wherein [symbol] ER₁R₂ is represented by a formula —S—(CH₂)_{n″}CH₃, where n” is an integer from 1 to 10.

24. The poly(aryl ether) (PAE) polymer of claim 17, wherein the poly(aryl ether) (PAE) polymer further comprises recurring unit (R_{PAE}**), wherein the recurring unit (R_{PAE}**) is represented by a formula selected from the following group of formulae consisting of: 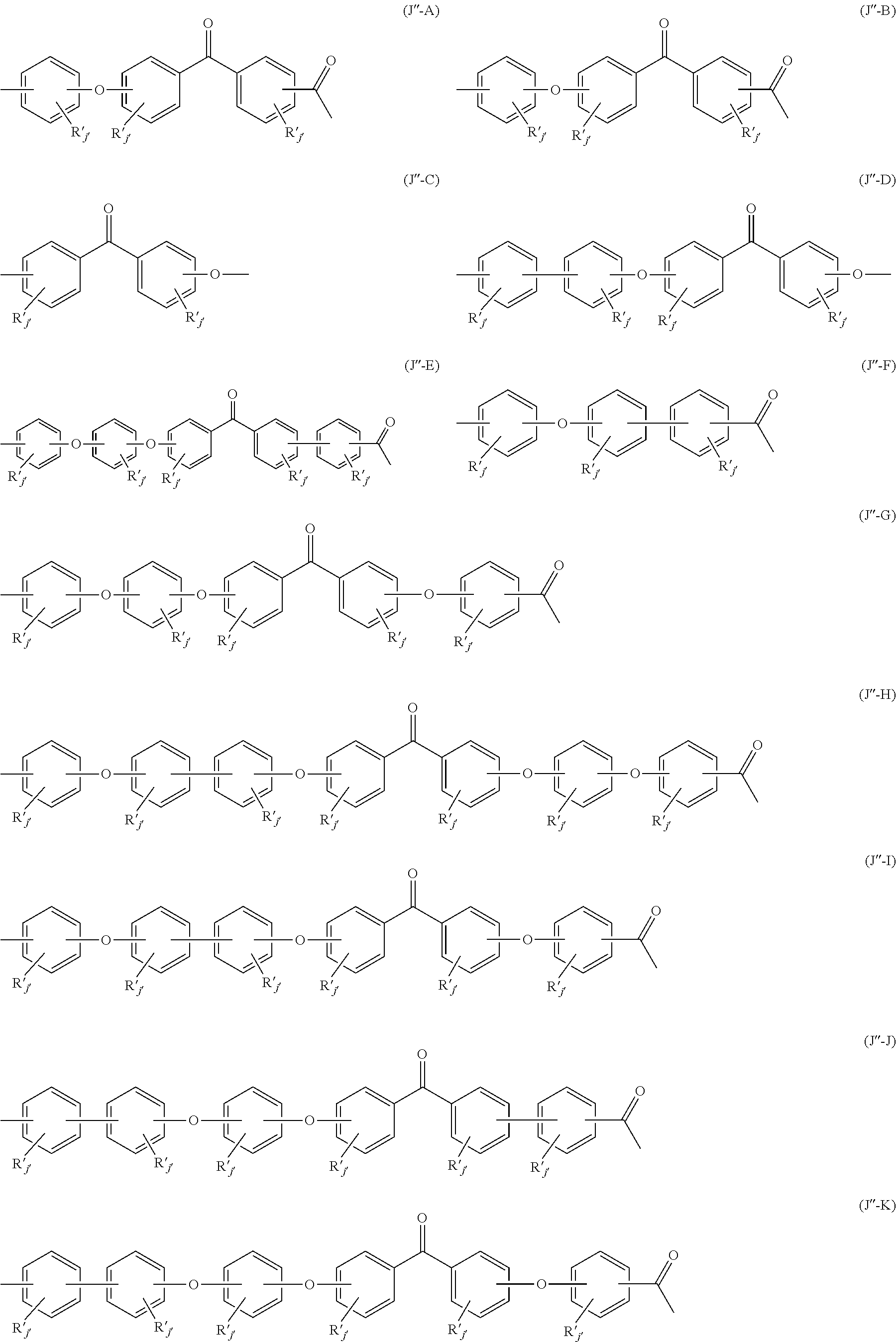 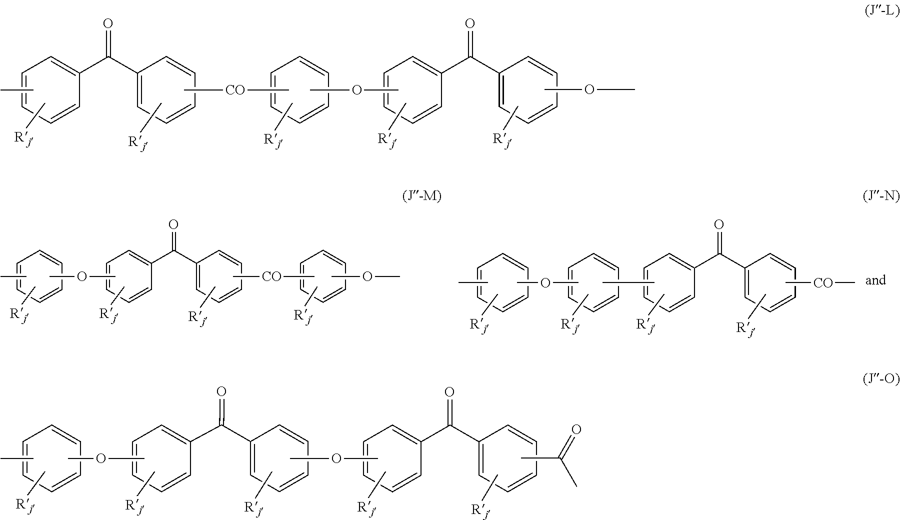
wherein:
each R′ⱼ, is independently selected from the group consisting of a halogen, an alkyl, an alkenyl, an alkynyl, an aryl, an ether, a thioether, a carboxylic acid, an ester, an amide, an imide, an alkali or alkaline earth metal sulfonate, an alkyl sulfonate, an alkali or alkaline earth metal phosphonate, an alkyl phosphonate, an amine and a quaternary ammonium; and
each j′ is an independently selected integer from 0 to 4.

25. A PAE adhesive composition comprising:
the poly(aryl ether) (PAE) polymer of claim 17; and
a poly(aryl ether ketone) (PAEK) polymer.

26. A polymer-metal junction comprising:
a metal substrate; and
an PAE adhesive composition comprising the PAE polymer of claim 17, wherein the PAE adhesive composition is disposed on at least a portion of the metal substrate.

27. The polymer-metal junction of claim 26, further comprising a PAEK polymer disposed on at least one portion of the adhesive composition, wherein the PAEK polymer comprises recurring unit (R_{PAEK}) represented by a formula selected from the following group of formulae consisting of:

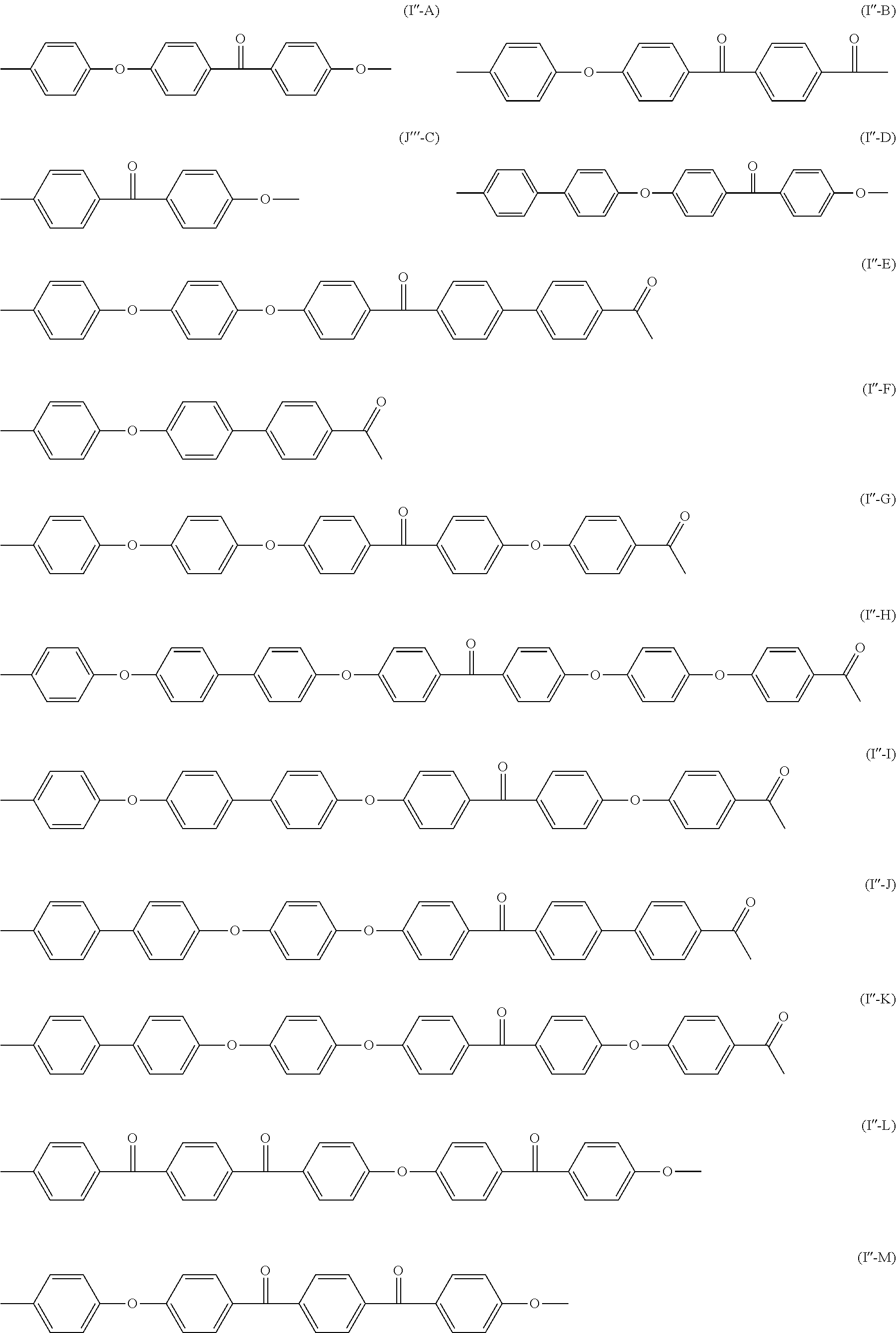

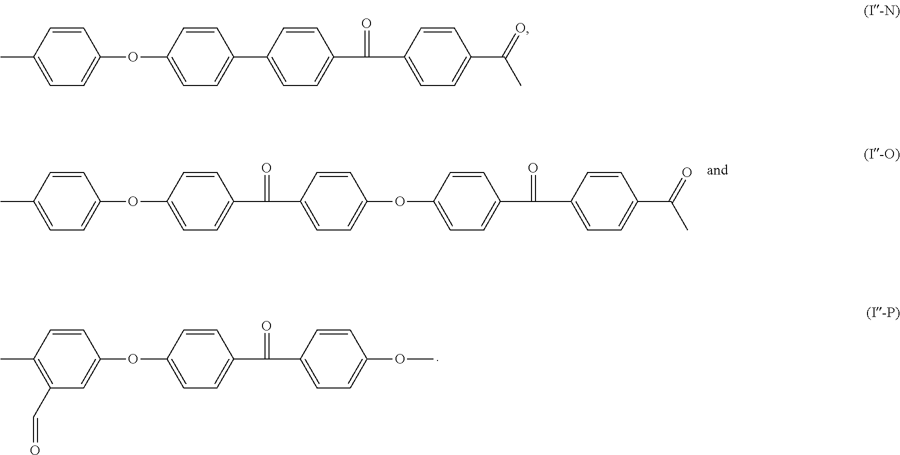

28. A double butt lap joint having a surface area of about 0.25 square inches and shaped according to the ASTM D1002 standard comprising the polymer-metal junction of claim 26, wherein the polymer-metal junction has a lap shear stress of about 1 mega MPa.

29. A coated wire comprising the polymer-metal junction of claims 26, wherein the wire comprises the metal substrate and wherein the coating comprises the PAE polymer.

30. A snap fit connector, a circuit board, a microphone, a speaker, a display, a battery, a cover, a housing, an electrical or electronic connector, a hinge, a radio antenna, a switch, or a switchpad comprising a mobile electronic device component comprising the polymer-metal junction of claim 26.

31. A mobile electronic device comprising a mobile electronic device component comprising the polymer-metal junction of claim 26, wherein the mobile electronic device is selected from the group consisting of a mobile phone, a personal digital assistant, a laptop computer, a tablet computer, a wearable computing device, a camera, a portable audio player, a portable radio, a global position system receiver, and portable game console.

32. A method of forming the polymer-metal junction of claim 26, the method comprising:
molding the PAE polymer onto at least a portion of the metal substrate, wherein the molding is selected from solution coating, injection molding, compression molding, and powder coating.

33. The double butt lap joint of claim 28, wherein the polymer-metal junction has a lap shear stress of at least about 6 MPa.

34. The double butt lap joint of claim 28, wherein the polymer-metal junction has a lap shear stress of at least about 8 MPa.

35. The double butt lap joint of claim 28, wherein the polymer-metal junction has a lap shear stress of at least about 10 MPa.
